(19) United States
(12) Patent Application Publication
(10) Pub. No.: US 2020/0008028 A1
(43) Pub. Date: Jan. 2, 2020

(54) VEHICLE BEHAVIOR MONITORING SYSTEMS AND METHODS

(71) Applicant: SZ DJI TECHNOLOGY CO., LTD., Shenzhen (CN)

(72) Inventor: Kang YANG, Shenzhen (CN)

(21) Appl. No.: 16/570,204

(22) Filed: Sep. 13, 2019

Related U.S. Application Data
(63) Continuation of application No. PCT/CN2017/078087, filed on Mar. 24, 2017.

(51) Int. Cl. H04W 4/48; H04W 4/46; G08G 1/01; H04W 4/44; G06Q 40/08

(52) U.S. Cl. CPC H04W 4/48; H04W 4/46; G05D 1/0255; H04W 4/44; G06Q 40/08; G08G 1/0112

(57) ABSTRACT

A method of analyzing vehicle data includes collecting behavior data of one or more surrounding vehicles with aid of one or more sensors on-board a sensing vehicle and analyzing the behavior data of the one or more surrounding vehicles with aid of one or more processors to determine a safe driving index for each of the one or more surrounding vehicles.

### BACKGROUND OF THE DISCLOSURE

Traditionally, usage-based insurance (UBI) for cars, are provided based on user behavior. The user behavior is analyzed using an in-vehicle computer or reading built-in sensors on a mobile device with an application. Such collected information is limited because no environmental information is available. With such limited information, it is difficult to determine whether a driver of a vehicle is operating the vehicle in a safe manner.

For example, such a system would not be capable of detecting unsafe behaviors, such as running a red light or speeding. Such a system would also not be able to detect unsafe lane changes.

### SUMMARY OF THE DISCLOSURE

A need exists for systems and methods for monitoring vehicle behavior. A need exists to determine how safely one or more vehicles are behaving. Such information is useful for providing usage-based insurance (UBI) car insurance, and/or providing driving assistance. Vehicle behavior monitoring systems and methods may be provided. A sensing vehicle may comprise one or more sensors on-board the vehicle. The one or more sensors may collect behavior data about one or more surrounding vehicles within a detectable range of the sensing vehicle. Optionally, one or more sensors on-board a sensing vehicle may provide behavior data about the sensing vehicle. Such information may be used to generate a safe driving index for the one or more surrounding vehicles, and/or the sensing vehicle. The safe driving index may be associated with a vehicle identifier of a corresponding vehicle, and/or a driver identifier of a driver operating the corresponding vehicle.

Aspects of the disclosure are directed to a method of analyzing vehicle data, said method comprising: collecting, with aid of one or more sensors on-board a sensing vehicle, behavior data of one or more surrounding vehicles; and analyzing, with aid of one or more processors, the behavior data of the one or more surrounding vehicles to determine a safe driving index for each of the one or more surrounding vehicles.

Further aspects of the disclosure are directed to a system for analyzing vehicle data, said system comprising: one or more sensors on-board a sensing vehicle, wherein the one or more sensors are configured to collect behavior data of one or more surrounding vehicles; and one or more processors configured to analyze the behavior data of the one or more surrounding vehicles to determine a safe driving index for each of the one or more surrounding vehicles.

Additionally, aspects of the disclosure are directed to a method of analyzing vehicle data, said method comprising: collecting, with aid of one or more sensors on-board a sensing vehicle, behavior data of one or more surrounding vehicles; associating the behavior data of the one or more surrounding vehicles with one or more corresponding vehicle identifiers of the one or more surrounding vehicles; and analyzing, with aid of one or more processors, the behavior data of the one or more surrounding vehicles.

A system for analyzing vehicle data may be provided in accordance with another aspect of the disclosure. The system may comprise: one or more sensors on-board a sensing vehicle, wherein the one or more sensors are configured to collect behavior data of one or more surrounding vehicles; and one or more processors configured to (1) associate the behavior data of the one or more surrounding vehicles with one or more corresponding vehicle identifiers of the one or more surrounding vehicles and (2) analyze the behavior data of the one or more surrounding vehicles.

Moreover, aspects of the disclosure may be directed to a method of analyzing vehicle data, said method comprising: collecting, with aid of one or more sensors on-board a sensing vehicle, behavior data of one or more surrounding vehicles; associating the behavior data of the one or more surrounding vehicles with one or more corresponding driver identifiers of one or more drivers operating the one or more surrounding vehicles; and analyzing, with aid of one or more processors, the behavior data of the one or more surrounding vehicles.

Aspects of the disclosure may also be directed to a system for analyzing vehicle data, said system comprising: one or more sensors on-board a sensing vehicle, wherein the one or more sensors are configured to collect behavior data of one or more surrounding vehicles; and one or more processors configured to (1) associate the behavior data of the one or more surrounding vehicles with one or more corresponding driver identifiers of one or more drivers operating the one or more surrounding vehicles and (2) analyze the behavior data of the one or more surrounding vehicles.

Further aspects of the disclosure may comprise a method of analyzing vehicle data, said method comprising: collecting, with aid of one or more sensors on-board a sensing vehicle, (1) behavior data of the sensing vehicle and (2) behavior data of one or more surrounding vehicles; and analyzing, with aid of one or more processors, (1) the behavior data of the sensing vehicle and (2) the behavior data of one or more surrounding vehicles to determine a safe driving index for the sensing vehicle.

In accordance with additional aspects of the disclosure, a system for analyzing vehicle data may be provided. The system may comprise: one or more sensors on-board a sensing vehicle, wherein the one or more sensors are configured to collect behavior data of one or more surrounding vehicles; and one or more processors configured to analyze (1) the behavior data of the sensing vehicle and (2) the behavior data of one or more surrounding vehicles to determine a safe driving index for the sensing vehicle.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings (also “Figure” and “FIG.” herein), of which:

FIG. 1 shows an example of a vehicle, in accordance with embodiments of the disclosure.

FIG. 2 shows an example of a sensing vehicle and one or more surrounding vehicles in accordance with embodiments of the disclosure.

FIG. 3 shows an example of vehicles that may communicate with one another, in accordance with embodiments of the disclosure.

FIG. 4 shows an example of multiple sensing vehicles, in accordance with embodiments of the disclosure.

FIG. 5 shows an example of a sensing vehicle tracking a surrounding vehicle, in accordance with embodiments of the disclosure.

FIG. 6 shows an example of a vehicle monitoring system, in accordance with embodiments of the disclosure.

FIG. 7 illustrates data aggregation and analysis from one or more sensing vehicles, in accordance with embodiments of the disclosure.

FIG. 8 illustrates data that may be collected from one or more sensing vehicles, in accordance with embodiments of the disclosure.

FIG. 9 shows an example of driver identification, in accordance with embodiments of the disclosure.

FIG. 10 illustrates an additional example of data aggregation and analysis from one or more sensing vehicles, in accordance with embodiments of the disclosure.

FIG. 11 illustrates an additional example of data that may be collected from one or more sensing vehicles, in accordance with embodiments of the disclosure.

FIG. 12 shows an example of a functional hierarchy of a vehicle system, in accordance with embodiments of the disclosure.

FIG. 13 provides an illustration of data analysis for determining a safe driving index for a sensing vehicle, in accordance with embodiments of the disclosure.

### DETAILED DESCRIPTION OF THE EMBODIMENTS

Systems, methods, and devices are provided for monitoring vehicle behavior. A sensing vehicle may have one or more sensors on-board the vehicle. The sensors may be useful for detecting behavior of one or more surrounding vehicles and/or the sensing vehicle itself. The behavior data of the one or more surrounding vehicles and/or the sensing vehicle may be collected and/or aggregated, and analyzed. The analyzed behavior may be used to detect safe or unsafe driving behavior by the one or more surrounding vehicles and/or the sensing vehicle. A safe driving index may be generated and associated with a vehicle identifier of a corresponding vehicle and/or driver identifier of a driver operating the corresponding vehicle. Data from a single sensing vehicle or multiple sensing vehicles may be aggregated and/or analyzed. The data may be collected and/or analyzed at one or more data center off-board the vehicles. Alternatively or in addition, data may be collected and/or analyzed at one or more of the vehicles.

In some instances, data collected by a single sensing vehicle or multiple sensing vehicles may be used to track a particular vehicle, even if vehicle or driver-identifying information if out of detectable range for one or more stretches of time. The collective information may be useful for identifying vehicles and/or data. The collective information may also provide context to behavior of the various vehicles, which may be useful in making an assessment of whether a particular behavior is safe or unsafe. For instance, the vehicle monitoring systems and methods provided herein may advantageously be able to detect when a vehicle (whether a surrounding vehicle or the surrounding vehicle itself) is running a red light or speeding. The systems and methods provided herein may be able to differentiate between safe and unsafe lane changing behaviors or may be able to detect accidents and make a determination as to fault of the participants in the accident.

The analyzed information may be useful for providing usage based insurance (UBI) vehicle insurance. For instance, different rates or terms may apply for vehicles or drivers who are identified as having safe driving practices, versus those who engage in unsafe driving practices. Such aggregated information may also be useful for providing driver's assistance or other applications. In some instances large amounts of data may be aggregated and analyzed together. Further applications may include incentives to change or improve various driving habits of individuals, and/or aid in the development of semi-autonomous or autonomous driving systems.

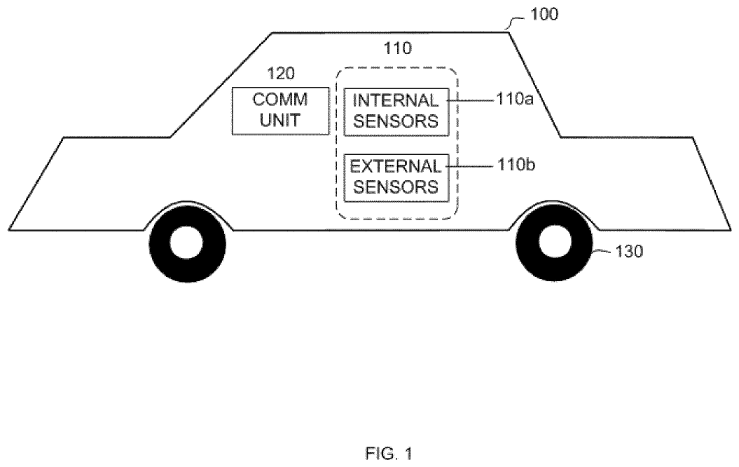

FIG. 1 shows an example of a vehicle, in accordance with embodiments of the disclosure. The vehicle 100 may comprise one or more propulsion systems 130 that may enable the vehicle to move within an environment. The vehicle may be a sensing vehicle that comprises one or more sensors 110. The sensors may comprise one or more internal sensors 110a that may sense information relating to the sensing vehicle. The sensors may comprise one or more external sensors 110b that may sense information relating to one or more surrounding vehicles outside the sensing vehicle. The vehicle may comprise a communication unit 120 that may enable the vehicle to communicate with an external device.

The vehicle 100 may be any type of vehicle. For instance, the vehicle may be capable of moving within an environment. A vehicle may be configured to move within any suitable environment, such as in air (e.g., a fixed-wing aircraft, a rotary-wing aircraft, or an aircraft having neither fixed wings nor rotary wings), in water (e.g., a ship or a submarine), on ground (e.g., a motor vehicle, such as a car, truck, bus, van, motorcycle; or a train), under the ground (e.g., a subway), in space (e.g., a spaceplane, a satellite, or a probe), or any combination of these environments. Suitable vehicles may include water vehicles, aerial vehicles, space vehicles, or ground vehicles. For example, aerial vehicles may be fixed-wing aircraft (e.g., airplane, gliders), rotary-wing aircraft (e.g., helicopters, rotorcraft), aircraft having both fixed wings and rotary wings, or aircraft having neither (e.g., blimps, hot air balloons). In one example, automobiles, such as sedans, SUVs, trucks (e.g., pickup trucks, garbage trucks, other types of trucks), vans, mini-vans, buses, station wagons, compacts, coupes, convertibles, semi's, armored vehicles, or other land-bound vehicles such as trains, monorails, trolleys, cable cars, and so forth may be described. Any description herein of any type of vehicle may apply to any other type of vehicle, capable of operating within the same environment or within different environments.

The vehicle may always be in motion, or may be at motions for portions of a time. For example, the vehicle may be a car that may stop at a red light and then resume motion, or may be a train that may stop at a station and then resume motion. The vehicle may move in a fairly steady direction or may change direction. The vehicle may move on land, underground, in the air, on or in the water, and/or in space. The vehicle may be a non-living moving object (e.g., moving vehicle, moving machinery, object blowing in wind or carried by water, object carried by living target).

A vehicle may be capable of moving freely within the environment with respect to three degrees of freedom (e.g., three degrees of freedom in translation) or two degrees of freedom (e.g., two degrees of freedom in translation). In some other embodiments, a vehicle may be capable of moving in six degrees of freedom (e.g., three degrees of freedom in translation and three degrees of freedom in rotation). Alternatively, the movement of the moving object can be constrained with respect to one or more degrees of freedom, such as by a predetermined path, track, or orientation. The movement can be actuated by any suitable actuation mechanism, such as an engine or a motor. For example, the vehicle may comprise an internal combustion engine (ICE), may be an electric vehicle (e.g., hybrid electric vehicle plug-in vehicle, battery-operated vehicle, etc.), hydrogen vehicle, steam-driven vehicle, and/or alternative fuel vehicle. The actuation mechanism of the vehicle can be powered by any suitable energy source, such as electrical energy, magnetic energy, solar energy, wind energy, gravitational energy, chemical energy, nuclear energy, or any suitable combination thereof.

The vehicle may be self-propelled via a propulsion system. The propulsion system may optionally run on an energy source, such as electrical energy, magnetic energy, solar energy, wind energy, gravitational energy, chemical energy, nuclear energy, or any suitable combination thereof. The propulsion system may comprise one or more propulsion units 130, such as wheels, treads, tracks, paddles, propellers, rotor blades, jet engines, or other types of propulsion units. A vehicle can be self-propelled, such as self-propelled through the air, on or in water, in space, or on or under the ground. A propulsion system may include one or more engines, motors, wheels, axles, magnets, rotors, propellers, blades, nozzles, or any suitable combination thereof.

A vehicle may be a passenger vehicle. One or more individual may ride within a vehicle. The vehicle may be operated by one or more drivers. A driver may completely or partially operate the vehicle. In some instances, the vehicle may be fully manually controlled (e.g., may be fully controlled by the driver), may be semi-autonomous (e.g., may receive some driver inputs, but may be partially controlled by instructions generated by one or more processors, or may be fully autonomous (e.g., may operate in response to instructions generated by one or more processors). In some instances, a driver may or may not provide any input that directly controls movement of the vehicle in one or more directions. For example, a driver may directly and manually drive a vehicle by turning a steering wheel and/or depressing an accelerator or brake. In some instances a driver may provide an input that may initiate an automated series of events, which may include automated movement of the vehicle. For example, a driver may indicate a destination, and the vehicle may autonomously take the driver to the indicated destination.

In other embodiments, the vehicle may optionally not carry any passengers. The vehicle may be sized and/or shaped such that passengers may or may not ride on-board the vehicle. The vehicle may be a remotely controlled vehicle. The vehicle may be a manned or unmanned vehicle.

One or more sensors 110 may be on-board the vehicle. The vehicle may bear weight of the one or more sensors. The one or more sensors may move with the vehicle. The sensors may be partially or completely enclosed within a vehicle body, may be incorporated into the vehicle body, or may be provided external to the vehicle body. The sensors may be within a volume defined by one or more vehicle body panels, or may be provided in or on the vehicle body panels. The sensors may be provided within a volume defined by a vehicle chassis, or may be provided in or on the vehicle chassis. The sensors may be provided outside a volume defined by a vehicle chassis. The sensors may be rigidly affixed to the vehicle or may move relative to the vehicle. The sensors may be rigidly affixed relative to one or more components of the vehicle (e.g., chassis, window, panel, bumper, axle) or may move relative to one or more components of the vehicle. In some instances, the sensors may be attached with aid of one or more gimbals that may provide controlled movement of the sensor relative to the vehicle or a component of the vehicle. The movement may include translational movement and/or rotational movement relative to a yaw, pitch, or roll axis of the sensor.

A sensor can be situated on any suitable portion of the vehicle, such as above, underneath, on the side(s) of, or within a vehicle body of the vehicle. Some sensors can be mechanically coupled to the vehicle such that the spatial disposition and/or motion of the vehicle correspond to the spatial disposition and/or motion of the sensors. The sensor can be coupled to the vehicle via a rigid coupling, such that the sensor does not move relative to the portion of the vehicle to which it is attached. Alternatively, the coupling between the sensor and the vehicle can permit movement of the sensor relative to the vehicle. The coupling can be a permanent coupling or non-permanent (e.g., releasable) coupling. Suitable coupling methods can include adhesives, bonding, welding, and/or fasteners (e.g., screws, nails, pins, etc.). Optionally, the sensor can be integrally formed with a portion of the vehicle. Furthermore, the sensor can be electrically coupled with a portion of the vehicle (e.g., processing unit, control system, data storage) so as to enable the data collected by the sensor to be used for various functions of the vehicle (e.g., navigation, control, propulsion, communication with a user or other device, etc.), such as the embodiments discussed herein.

The one or more sensors may comprise zero, one, two or more internal sensors 110a and/or zero, one, two or more external sensors 110b. Internal sensors may be used to detect behavior data relating to the sensing vehicle itself. External sensors may be used to detect behavior data relating to an object outside the sensing vehicle, such as one or more surrounding vehicles. The external sensors may or may not be used to detect information relating to an environment around the vehicle, such as ambient conditions, external objects (e.g., moving or non-moving), driving conditions, and so forth. Any description herein of sensors on-board the vehicle may apply to internal sensors and/or the external sensors. Any description herein of an internal sensor may optionally be applicable to an external sensor, and vice versa. In some instances, a vehicle may carry both internal and external sensors. One or more of the internal and external sensors may be the same, or may be different from one another. For instance, the same or different types of sensors may be carried for internal and external sensors, or one or more different parameters of the sensors (e.g., range, sensitivity, precision, direction, etc.) may be the same or different for internal and external sensors.

In one example internal sensors 110a may be useful for collecting behavior data of the sensing vehicle. For example, one or more internal sensors may comprise one or more navigational sensors that may be useful for detecting position information pertaining to the sensing vehicle. Position information may include spatial location (relative to one, two, or three orthogonal translational axes), linear velocity (relative to one, two, or three orthogonal axes of movement), linear acceleration (relative to one, two or three orthogonal axes of movement), attitude (relative to one, two, or three axes of rotation), angular velocity (relative to one, two, or three axes of rotation), and/or angular acceleration (relative to one, two or three axes of rotation). The position information may include geo-spatial coordinates of the sensing vehicle. The position information may include a detection and/or measurement of movement of the sensing vehicle. The internal sensors may measure forces or moments applied to the sensing vehicle. The forces or moments may be measured with respect to one, two, or three axes. Such forces or moments may be linear and/or angular forces or moments. The internal sensors may measure impacts/collisions experienced by the sensing vehicle. The internal sensors may detect scrapes or bumps experienced by the sensing vehicle. The internal sensors may detect if an accident occurs that affects the structural integrity of the sensing vehicle. The internal sensors may detect if an accident occurs that damages a component of the sensing vehicle and/or deforms a component of the sensing vehicle.

The internal sensors may measure other conditions relating to the sensing vehicle. For example, the internal sensors may measure temperature, vibrations, magnetic forces, or wireless communications, experienced by the sensing vehicle. The internal sensors may measure a characteristic of a component of the vehicle that may be in operation. For example, the internal sensors may measure fuel consumed, energy used, power inputted to a propulsion unit, power outputted by a propulsion unit, power consumed by a communication unit, parameters affecting operation of a communication unit, error state of one or more components, or other characteristics of the vehicle.

The internal sensors may include, but are not limited to global positioning system (GPS) sensors, inertial sensors (e.g., accelerometers (such as 1-axis, 2-axis or 3-axes accelerometers), gyroscopes, magnetometers), temperature sensors, vision sensors, or any other type of sensors.

In one example external sensors 110b may be useful for collecting behavior data of an object (e.g., one or more surrounding vehicles) or environment outside the sensing vehicle. For example, one or more external sensors may be useful for detecting position information pertaining to one or more surrounding vehicles. Position information may include spatial location (relative to one, two, or three orthogonal translational axes), linear velocity (relative to one, two, or three orthogonal axes of movement), linear acceleration (relative to one, two or three orthogonal axes of movement), attitude (relative to one, two, or three axes of rotation), angular velocity (relative to one, two, or three axes of rotation), and/or angular acceleration (relative to one, two or three axes of rotation). The position information may include geo-spatial coordinates of the one or more surrounding vehicles. For example, the positional information may include latitude, longitude, and/or altitude of the one or more surrounding vehicles. The position information may include a detection and/or measurement of movement of the sensing vehicle. The position information may be relative to the sensing vehicle, or relative to an inertial reference frame. For example, the position information may include distance and/or direction relative to the sensing vehicle. For instance the positional information may designate that the surrounding vehicle is 5 meters away and 90 degrees to the right of the sensing vehicle.

The external sensors may measure other conditions relating to the one or more surrounding vehicle, other external objects, or surrounding environment. For example, the external sensors may measure temperature, vibrations, forces, moments, or wireless communications, experienced by the one or more surrounding vehicle. The external sensors may be able to detect accidents experienced by one or more surrounding vehicles. The external sensors may detect impacts/collisions experienced by the surrounding vehicle. The external sensors may detect scrapes or bumps experienced by the surrounding vehicle. The external sensors may detect if an accident occurs that affects the structural integrity of the surrounding vehicle. The external sensors may detect if an accident occurs that damages a component of the surrounding vehicle and/or deforms a component of the surrounding vehicle.

The external sensors may include, but are not limited to global positioning system (GPS) sensors, temperature sensors, vision sensors, ultrasonic sensors, laser radar, microwave radar, infrared sensors, or any other type of sensors.

The one or more sensors 110 carried by the sensing vehicle may include, but are not limited to location sensors (e.g., global positioning system (GPS) sensors, mobile device transmitters enabling location triangulation), vision sensors (e.g., imaging devices capable of detecting visible, infrared, or ultraviolet light, such as cameras), proximity sensors (e.g., ultrasonic sensors, lidar, time-of-movement cameras), inertial sensors (e.g., accelerometers, gyroscopes, inertial measurement units (IMUs)), altitude sensors, pressure sensors (e.g., barometers), audio sensors (e.g., microphones) or field sensors (e.g., magnetometers, electromagnetic sensors). Any suitable number and combination of sensors can be used, such as one, two, three, four, five, or more sensors. Optionally, the data can be received from sensors of different types (e.g., two, three, four, five, or more types). Sensors of different types may measure different types of signals or information (e.g., position, orientation, velocity, acceleration, proximity, pressure, etc.) and/or utilize different types of measurement techniques to obtain data. For instance, the sensors may include any suitable combination of active sensors (e.g., sensors that generate and measure energy from their own source) and passive sensors (e.g., sensors that detect available energy).

The vehicle may comprise one or more communication units 120. The communication unit may permit the sensing vehicle to communicate with one or more external device. In some embodiments, the external device may comprise one or more surrounding vehicles. For example, the sensing vehicle may communicate directly with one or more surrounding vehicles, or may communicate with one or more surrounding vehicles over a network or via one or more intermediary devices.

The communication unit may permit the sensing vehicle to communicate with one or more data centers that may collect and/or aggregate information the sensing vehicle and/or other sensing vehicles. The one or more data centers may be provided on one or more external devices, such as one or more servers, personal computers, mobile devices, and/or via a cloud computing or peer-to-peer infrastructure.

The communication unit may permit wireless communication between the sensing vehicle and one or more external devices. The communication unit may permit one-way communication (e.g., from the sensing vehicle to the external device, or from the external device to the sensing vehicle), and/or two-way communications (e.g., between the sensing vehicle and one or more external devices). The communication unit may have a limited distance or range. The communication unit may be capable of long-range communications. The communication unit may engage in point-to-point communications. The communication unit may be broadcasting information.

In one example, the communication unit may comprise one or more transceivers. The communication unit may comprise a transmitter and/or a receiver. The communication unit may be configured for any type of wireless communication as described elsewhere herein. The communication unit may comprise one or more antennas that may aid in the communications. The communication unit may or may not include a communication dish. The communication unit may be directional (e.g., operate strongest in a specified direction) or may operate substantially uniformly across all directions.

A communication unit 120 may be in communication with one or more sensors 110. The communication unit may receive data collected by the one or more sensors. In some embodiments, data collected by one or more sensors may be transmitted using the communication unit. The data transmitted by the communication unit may optionally be raw data collected by the one or more sensors. Alternatively or in addition, the data transmitted by the communication unit may be pre-processed on-board the vehicle. In some embodiments, a sensing vehicle may have one or more on-board processors that may perform one or more pre-processing steps on the data collected by the sensors, prior to transmission of data to the communication unit. The pre-processing may or may not include formatting of the data into a desired form.

The pre-processing may or may not include analysis of the sensor data with respect to the sensing vehicle and/or with respect to an inertial reference frame (e.g., the environment). For instance, the pre-processing may or may not include determination of positional information relating to the one or more surrounding vehicles or the sensing vehicle. The positional information may be with respect to the sensing vehicle or with respect to the inertial reference frame (e.g., geo-spatial coordinates). For instance, the sensing vehicle may be able to determine location and/or movement information for the sensing vehicle or one or more surrounding vehicles.

The communication unit may be positioned anywhere on or in the vehicle. The communication unit may be provided within a volume contained by one or more body panels of the vehicle. The communication unit may be provided within a volume within a vehicle chassis. The communication unit may be external to a housing or body of the vehicle.

The vehicle may comprise one or more on-board processors. The one or more processors may form an on-board computer or controller. For instance, the vehicle may comprise an electronic control unit (ECU). The ECU may provide instructions for one or more activities of the vehicle, which may include, but are not limited to, propulsion, steering, braking, fuel regulation, battery level regulation, temperature, communications, sensing, or any other operations. The one or more processors may be or may comprise a central processing unit (CPU), graphics processing unit (GPU), field-programmable gate array (FPGA), digital signal processor (DSP) and so forth.

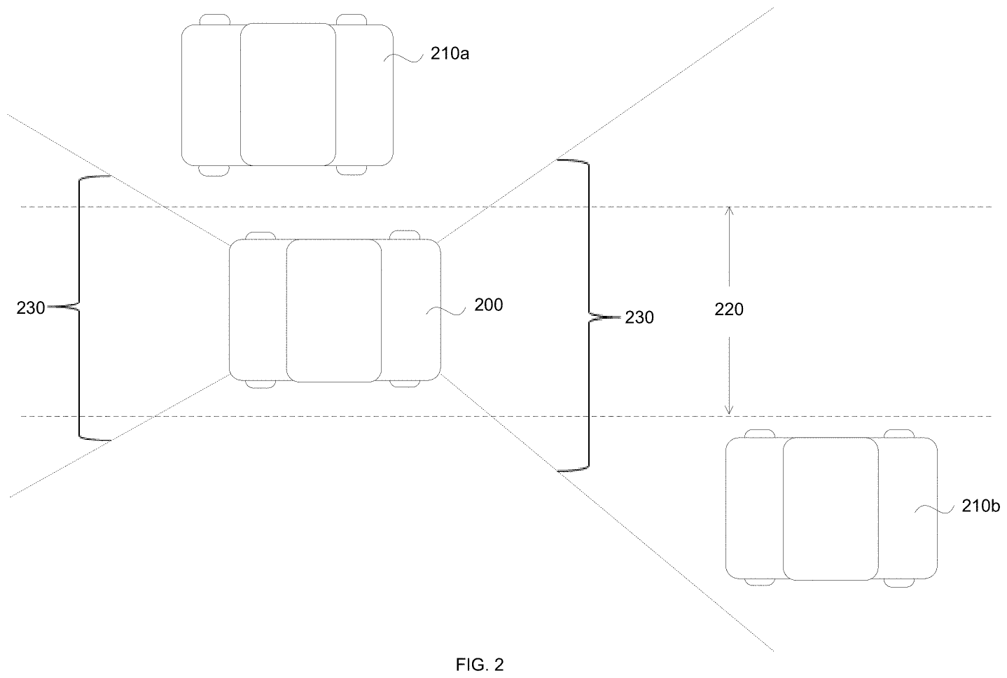

FIG. 2 shows an example of a sensing vehicle and one or more surrounding vehicles in accordance with embodiments of the disclosure. A sensing vehicle 200 may comprise one or more sensors that may be capable of detecting one or more surrounding vehicles 210a, 210b. The one or more sensors may have a detectable range 230. A sensing vehicle may be traveling on a roadway, which may optionally have one or more lanes and/or lane dividers 220.

A sensing vehicle 200 may comprise one or more sensors. The sensors may be capable of detecting one or more surrounding vehicles 210a, 210b. The one or more surrounding vehicles may or may not comprise their own sensors. The one or more surrounding vehicles may comprise sensors that may be capable of detecting vehicles that surround the one or more surrounding vehicles. The one or more surrounding vehicles to a particular sensing vehicle, may or may not be sensing vehicles as well. The sensing vehicle may optionally comprise one or more sensors that may detect a condition of the sensing vehicle itself. The one or more sensors used to detect the one or more surrounding vehicles may be the same sensors or same sensor type as the one or more sensors that may detect a condition of the sensing vehicle. The one or more sensors used to detect the one or more surrounding vehicles may be different sensors or different sensor types as the one or more sensors that may detect a condition of the sensing vehicle.

The one or more sensors of a sensing vehicle may have a detectable range 230. In some instances, the detectable range may relate to a direction relative to the sensing vehicle. For instance, the detectable range may span an aggregated amount of less than or equal to about 15 degrees, 30 degrees, 45 degrees, 60 degrees, 75 degrees, 90 degrees, 120 degrees, 150 degrees, 180 degrees, 210 degrees, 240 degrees, 270 degrees, or 360 degrees around the vehicle. The detectable range may span an aggregated amount of greater than any of the values provided. The detectable range may be within a range between any two of the values provided herein. These may include lateral degrees around the vehicle. These may include vertical degrees around the vehicle. These may include both lateral and vertical degrees around the vehicle. Any of the aggregated amount of the detectable range may be provided in a single continuous detectable range, or may be broken up over multiple detectable ranges that collectively form the aggregated amount. Any of the aggregated amount of detectable range may be measured using a single sensor or multiple sensors. For instance, the vehicle may have a single sensor that may have any of the detectable ranges provided herein. In another example, the vehicle may have two sensors, three sensors, four sensors, five sensors, six sensors, or more sensors that may collectively span the detectable ranges provided herein. When multiple sensors are provided, their detectable ranges may or may not overlap.

The detectable range may be provided in any direction or combination of directions relative to the sensing vehicle. For example, the detectable range may be towards the front, rear, left side, right side, bottom, top, or any combination thereof relative to the sensing vehicle. The detectable range may form a continuous area around the vehicle or may comprise multiple discontinuous areas. The detectable range may include a line-of-sight or other region relative to the one or more sensors.

In some instances, the detectable range may relate to a distance relative to the sensing vehicle. For example, a detectable range may be less than or equal to about 1 m, 3 m, 5 m, 10 m, 15 m, 20 m, 30 m, 40 m, 50 m, 70 m, 100 m, 200 m, 400 m, 800 m, 1000 m, 1500 m, 2000 m, or more. The detectable range may be greater than or equal to any of the values provided. The detectable range may be within a range between any two of the values provided herein.

Any combination of direction and/or distance relative to the sensing vehicle may be provided for the detectable range. In some instances, the detectable range may have the same distance, regardless of the direction. In other instances, the detectable range may have different distances, depending on the direction. The detectable range may be static relative to the sensing vehicle. Alternatively, the detectable range may be dynamic relative to the sensing vehicle. For instance, the detectable range may change over time. The detectable range may change based on environmental conditions (e.g., weather, precipitation, fog, temperature), surrounding traffic conditions (density, movement of surrounding vehicles), obstacles, power supply to sensors, age of sensors, and so forth.

In one example, the one or more sensors may comprise image sensors. The one or more image sensors may comprise one or more cameras. The cameras may be monocular cameras and/or stereo cameras. The cameras may be capable of capturing images of the surrounding environment. The detectable range may include a field of view of the one or more image sensors. Anywhere within a line-of-sight of the image sensors within the field of view of the one or more image sensors may be within the detectable range. For example, one or more image sensors may be provided at a front of the vehicle and may have a detectable range in front of the vehicle, and one or more image sensors may be provided at a back of the vehicle and may have a detectable range behind the vehicle.

One or more sensors of the sensing vehicle may have detectable ranges anywhere relative to the sensing vehicle. For example, one or more sensors may be provided at a front of the vehicle, and a detectable range may be provided toward the front of the vehicle. In another example, one or more sensors may be provided at a rear of the vehicle, and a detectable range may be provided toward the rear of the vehicle. One or more sensors may be provided on a side of the vehicle, such as a left side or right side of the vehicle, and a corresponding detectable range may be provided on the same side of the vehicle (e.g., left side or ride side, respectively). In another example, one or more sensors may be provided at a top portion of the vehicle, and a detectable range may be toward a top portion of the vehicle, or may encompass lateral portions of the vehicle (e.g., 360 all around the vehicle). In another example, the one or more sensors may be positioned at a bottom portion of the vehicle, and the detectable range may be beneath the vehicle, or may encompass lateral portions of the vehicle (e.g., 360 all around the vehicle). Different sensing vehicles may have the same detectable range as one another. Alternatively, different sensing vehicles may have different detectable ranges relative to one another.

In some instances, one or more of the surrounding vehicles 210b may come within the detectable range of the one or more sensors. In some instances, one or more surrounding vehicles 210a may not be within the detectable range of the sensors, even if the surrounding vehicle is close to the sensing vehicle. When a surrounding vehicle is not within a detectable range of the sensor, the surrounding vehicle may be within a blind spot of the sensing vehicle. Over time, one or more surrounding vehicles may come into the detectable range of the sensors, or move outside the detectable range of the sensors. In some instances, over time one or more of the surrounding vehicles may remain within the detectable range of the sensors, or remain outside the detectable range of the sensors.

A vehicle may travel within an environment. For example, the vehicle may travel over land, such as on a roadway. The roadway may be a single lane or multi-lane roadway. When the vehicle is traveling along a multi-lane roadway, one or more lane dividers 220 may be present. One or more sensors on-board the sensing vehicle may be capable of detecting the lane dividers. The one or more sensors capable of detecting the lane dividers may be the same sensors or different sensors as the sensors that may detect the one or more surrounding vehicles. The one or more sensors capable of detecting the lane dividers may be of the same sensor type or different sensor types as the sensors that may detect the one or more surrounding vehicles.

The one or more sensors may be capable of detecting other environmental features, such as curbs, walkways, edges of lanes, medians, obstacles, traffic lights, traffic signs, traffic cones, railings, or ramps. Any description herein of sensors detecting line dividers may be applied to any other type of environmental feature provided herein, and vice versa.

A sensing vehicle may be capable of detecting one or more surrounding vehicles regardless of the configurations or capabilities of the one or more surrounding vehicles. For example, the sensing vehicle may be able to detect a surrounding vehicle, regardless of whether the surrounding vehicle is a sensing vehicle, or does not have similar sensors on-board.

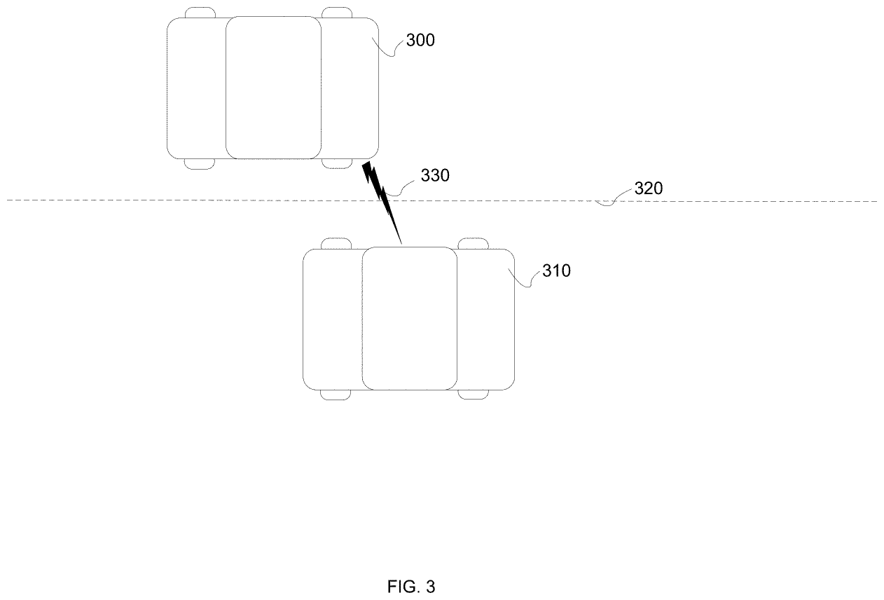

FIG. 3 shows an example of vehicles that may communicate with one another, in accordance with embodiments of the disclosure. In one example, a sensing vehicle 300 may communicate with one or more surrounding vehicles 310. The sensing vehicle and/or surrounding vehicles may be anywhere within an environment. In one example, they may be in different lanes, divided by one or more lane dividers 320. The sensing vehicle may communicate with the one or more surrounding vehicle using wireless communications 330.

A sensing vehicle 300 may be capable of receiving information about one or more surrounding vehicles 310. The sensing vehicle may communicate with the one or more surrounding vehicles wirelessly 330 to receive the information about the one or more surrounding vehicles. Alternatively or in addition, the sensing vehicle may employ one or more sensors that may collect information about the one or more surrounding vehicles. Any description herein of sensing vehicles sensing information may apply to the sensing vehicle.

A sensing vehicle may be a vehicle that obtains information about one or more surrounding vehicles. In one example, a first vehicle 300 may be a sensing vehicle that receives information about a second vehicle 310. The second vehicle may or may not be a sensing vehicle as well. For example, the second vehicle 310 may obtain information about the first vehicle 300 as well. In such a situation, the second vehicle may be a sensing vehicle as well. A sensing vehicle may obtain information about one or more surrounding vehicles by receiving information from an external source about the one or more surrounding vehicles and/or collecting the information about the one or more surrounding vehicles with one or more sensors on-board the sensing vehicle.

In some embodiments, the communication between the sensing vehicle and one or more surrounding vehicles may be one-way communication. For example, information may be provided from the one or more surrounding vehicles to the sensing vehicle. In some instances, the communication between the sensing vehicle and the one or more surrounding vehicles may be two-way communications. For example, information may be provided from the one or more surrounding vehicles to the sensing vehicle and vice versa.

The information received by the sensing vehicle may pertain to any type of information relating to the one or more surrounding vehicles. The information may comprise identification information for the surrounding vehicle. For example the identification information may comprise license plate information, vehicle identification number (VIN), vehicle type, vehicle, color, vehicle make, vehicle model, any physical features associated with the vehicle, and/or any performance characteristics associated with the vehicle.

The information may comprise identification information for a driver and/or owner of the surrounding vehicle. For example, the identification information may include an individual's name, driver's license information, address, contact information, age, accident history, and/or any other information associated with the individual.

The information may include any location information about the surrounding vehicle. For example, the information may comprise geo-spatial coordinates for the surrounding vehicle. The information may include latitude, longitude, and/or altitude of the surrounding vehicle. The information may include attitude information for the surrounding vehicle. For example, the information may include attitude with respect to a pitch axis, roll axis, and/or yaw axis. The information may include location information relative to an inertial reference frame (e.g., the environment). The information may or may not include location information relative to the sensing vehicle or any other reference.

The information may include any movement information about the surrounding vehicle. For example, the information may comprise a linear velocity, angular velocity, linear acceleration, and/or angular acceleration with respect to any direction of travel and/or angle of rotation. The information may include a direction of travel. The information may or may not include a planned direction of travel. The planned direction of travel may be based on navigational information entered into the one or more surrounding vehicles or a device carried within the one or more surrounding vehicles, or a current angle or trajectory of a steering wheel.

In some embodiments, the one or more surrounding vehicles may have one or more on-board sensors that may generate the location information and/or movement information, that may be communicated to the sensing vehicle. The on-board sensors may include navigational sensors, such as GPS sensors, inertial sensors, image sensors, or any other sensors described elsewhere herein.

The sensing information may or may not transmit similar information to the one or more surrounding vehicles. In some embodiments, the one or more surrounding vehicles may push the information out to the sensing vehicle. The one or more surrounding vehicles may be broadcasting the information. In other embodiments, the sensing vehicle may be pulling the information from the surrounding vehicle. The sensing vehicle may send one or more queries to the surrounding vehicle. The surrounding vehicle may respond to the one or more queries.

The communication between the vehicles may be a wireless communication. The communication may comprise direct communications between the vehicles. For example, the communication between the sensing vehicle and the surrounding vehicle may be a direct communication. A direct communication link may be established between the sensing vehicle and the surrounding vehicle. The direct communication link may remain in place while the sensing vehicle and/or the surrounding vehicle is in motion. The sensing vehicle and/or surrounding vehicle may be moving independently of one another. Any type of direct communication may be established between the sensing vehicle and the surrounding vehicle. For example, WiFi, WiMax, COFDM, Bluetooth, IR signals, optical signals, or any other type of direct communication may be employed. Any form of communication that occurs directly between two objects may be used or considered.

In some instances, direct communications may be limited by distance. Direct communications may be limited by line of sight, or obstructions. Direct communications may permit fast transfer of data, or a large bandwidth of data compared to indirect communications.

The communication between the sensing vehicle and the surrounding vehicle may be an indirect communication. Indirect communications may occur between the sensing vehicle and the surrounding vehicle with aid of one or more intermediary devices. In some examples the intermediary device may be a satellite, router, tower, relay device, or any other type of device. Communication links may be formed between a sensing vehicle and the intermediary device and communication links may be formed between the intermediary device and the surrounding vehicle. Any number of intermediary devices may be provided, which may communicate with one another. In some instances, indirect communications may occur over a network, such as a local area network (LAN) or wide area network (WAN), such as the Internet. In some instances, indirect communications may occur over a cellular network, data network, or any type of telecommunications network (e.g., 3G, 4G). A cloud computing environment may be employed for indirect communications.

In some instances, indirect communications may be unlimited by distance, or may provide a larger distance range than direct communications. Indirect communications may be unlimited or less limited by line of sight or obstructions. In some instances, indirect communications may use one or more relay device to aid in direct communications. Examples of relay devices may include, but are not limited to satellites, routers, towers, relay stations, or any other type of relay device.

A method for providing communications between a sensing vehicle and a surrounding vehicle may be provided, where the communication may occur via an indirect communication method. The indirect communication method may comprise communication via a mobile phone network, such as a 3G or 4G mobile phone network. The indirect communications may use one or more intermediary devices in communications between the sensing vehicle and the surrounding vehicle. The indirect communication may occur when the sensing vehicle and/or the surrounding vehicle is in motion.

Any combination of direct and/or indirect communications may occur between different objects. In one example, all communications may be direct communications. In another example, all communications may be indirect communications. Any of the communication links described and/or illustrated may direct communication links or indirect communication links. In some implementations, switching between direct and indirect communications may occur. For example, communication between a sensing vehicle and a surrounding vehicle may be direct communication, indirect communication, or switching between different communication modes may occur. Communication between any of the devices described (e.g., vehicle, data center) and an intermediary device (e.g., satellite, tower, router, relay device, central server, computer, tablet, smartphone, or any other device having a processor and memory) may be direct communication, indirect communication, or switching between different communication modes may occur.

In some instances, the switching between communication modes may be made automatically without requiring human intervention. One or more processors may be used to determine to switch between an indirect and direct communication method. For example, if quality of a particular mode deteriorates, the system may switch to a different mode of communication. The one or more processors may be on board the sensing vehicle, on-board the sensing vehicle, on board a third external device, or any combination thereof. The determination to switch modes may be provided from the sensing vehicle, the surrounding vehicle, and/or a third external device.

In some instances, a preferable mode of communication may be provided. If the preferable mode of communication is inoperational or lacking in quality or reliability, then a switch may be made to another mode of communication. The preferable mode may be pinged to determine when a switch can be made back to the preferable mode of communication. In one example, direct communication may be a preferable mode of communication. However, if the sensing vehicle and the surrounding vehicle are too far apart, or obstructions are provided between the sensing vehicle and the surrounding vehicle, the communications may switch to an indirect mode of communications. In some instances, direct communications may be preferable when a large amount of data is transferred between the sensing vehicle and the surrounding vehicle. In another example, an indirect mode of communication may be a preferable mode of communication. If the sensing vehicle and/or surrounding vehicle needs to quickly transmit a large amount of data, the communications may switch to a direct mode of communications. In some instances, indirect communications may be preferable when the sensing vehicle is at significant distances away from the surrounding vehicle and greater reliability of communication may be desired.

Switching between communication modes may occur in response to a command. The command may be provided by a user. The user may be an operator and/or passenger of the sensing vehicle and/or the surrounding vehicle.

In some instances, different communication modes may be used for different types of communications between the sensing vehicle and the surrounding vehicle. Different communication modes may be used simultaneously to transmit different types of data.

A sensing vehicle may communicate with any number of surrounding vehicles. The sensing vehicle may communicate with one or more surrounding vehicles, two or more surrounding vehicles, three or more surrounding vehicles, four or more surrounding vehicles, five or more surrounding vehicles, or ten or more surrounding vehicles. Such communications may occur simultaneously. Alternatively, such communications may occur sequentially or in a division switching manner. The same frequency channels may be used for these communications, or different frequency channels may be used for these communications.

The communications may comprise point to point communications between the vehicles. The communications may comprise broadcasted information from one or more vehicles. The communications may or may not be encrypted.

Any description herein of sensing vehicle obtaining information with aid of one or more sensors may also apply to the sensing vehicle obtaining information via communications with the one or more surrounding vehicles.

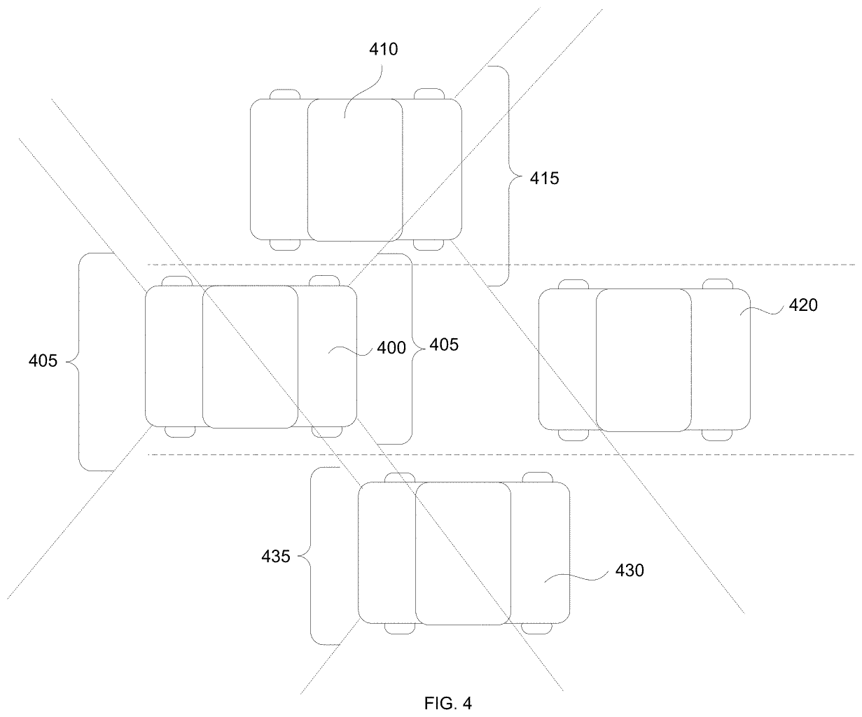

FIG. 4 shows an example of multiple sensing vehicles, in accordance with embodiments of the disclosure. One or more vehicles 400, 410, 420, 430 may be traversing an environment. One or more of the vehicles within an environment may be sensing vehicles.

A sensing vehicle 400 may have a detectable range 405. The detectable range may be relative to the sensing vehicle and/or an inertial reference frame. In one example, the detectable range may include areas in front of and behind the sensing vehicle. One or more of the surrounding vehicles may fall within the detectable range, such as vehicles 410, 420, 430.

Another sensing vehicle 410 within the area may have a detectable range 415. In one example, the detectable range may include areas in front of the sensing vehicle. One or more of the surrounding vehicles may fall within the detectable range, such as vehicle 420. One or more of the surrounding vehicles may fall outside the detectable range, such as vehicles 400, 430.

Another vehicle 420 may be within a proximity of one or more sensing vehicles. The one or more sensing vehicles and the other vehicle may be within the same geographical area. The vehicle may optionally not be a sensing vehicle, and may not have a corresponding detectable range. The vehicle may not be able to sense the surrounding vehicles 400, 410, 430.

Further, an additional sensing vehicle 430 may have a detectable range 435. In one example, the detectable range may include regions behind the sensing vehicle. One or more of the surrounding vehicles may fall within the detectable range, such as vehicle 400. One or more of the surrounding vehicles may fall outside the detectable range, such as vehicles 410, 420.

In some instances, sensing vehicles near one another may be able to sense one another (e.g., sensing vehicle 400 may sense sensing vehicle 430, and sensing vehicle 430 may be able to sense sensing vehicle 410). In some instances, a first sensing vehicle 430 may be able to sense a second sensing vehicle 410 but the second sensing vehicle 410 may not be able to sense the first sensing vehicle 400. Different sensing vehicles may have different detectable ranges. At different moments in times, surrounding vehicles may travel in or out of the detectable range of a particular sensing vehicle.

In some embodiments, when vehicles are able to sense one another, this may be useful for calibration or verification purposes. For instance, data sensed by multiple vehicles may be cross-checked to make sure the data is consistent. For example, a first vehicle may provide information about its location and location of a second vehicle. A third vehicle may provide information about its location and the location of the second vehicle. The information gathered by the first vehicle and the third vehicle regarding the location of the second vehicle may be cross-checked and compared. If the location information from both the first and third vehicles are consistent or within a tolerance range, the sensing function of the first and third vehicles may be validated. The second vehicle itself may or may not provide any information. In one example, the second vehicle may provide information about its location and the location of the first vehicle. The information gathered by the first vehicle and the third vehicle regarding the location of the second vehicle, and the self-reported location of the second vehicle may be cross-checked and compared. If the location from the first, second, and third vehicles are consistent or within a tolerance range, the sensing function from the first, second, and third vehicles may be validated. The information gathered by the first vehicle about the second vehicle may be compared with the self-reported information about the second vehicle, and the information gathered by the second vehicle about the first vehicle may be compared with the self-reported information about the first vehicle. Thus, various combinations of data may be compared. The calibration process may compare the various data sets and determine a reliability of the sensing function of the various vehicles. If the sensing functions are determined to be reliable, the systems and methods herein may rely on the data or put more weight on the data sensed by the calibrated vehicles. In some instances, if the data is inconsistent, then the systems and methods herein may put less weight on the data or ignore the data.

If any inconsistencies arise, the source of the inconsistency may be pinpointed. For instance, if most vehicles report a particular location for a target vehicle, except for one aberrant vehicle, the sensing function of that aberrant vehicle may be called into question and/or data from that aberrant vehicle may be discounted or ignored. In some instances, historical data and data sets may be analyzed to pinpoint one or more sources of inconsistency.

In some instances, the calibration function may also make adjustments in view of any detected inconsistencies. For instance, if the data sets are compared, and one of the vehicle sensors is consistently showing an offset relative to the other vehicles' sensors, any future data from that vehicle may have the offset corrected. For example, if one of the vehicles consistently shows that other vehicles are 3 meters north of where they really are, corrections may be made to the data gathered by the vehicle with the offset to yield a corrected data set.

A sensing vehicle may be any vehicle capable of sensing conditions of the sensing vehicle itself, or one or more surrounding vehicles (i.e., vehicles surrounding the sensing vehicle). A sensing vehicle may be any vehicle that may communicate information about its own status or the status of the one or more surrounding vehicles that have been sensed by the sensing vehicle. The one or more surrounding vehicles of a first a first sensing vehicle may or may not themselves be a sensing vehicle. For instance, a second vehicle may be within a sensing range of the first sensing vehicle. The second vehicle may or may not be a sensing vehicle. The second vehicle may be a second sensing vehicle. The second sensing vehicle may or may not sense the first sensing vehicle. The first sensing vehicle may be a vehicle that is a surrounding vehicle of the second sensing vehicle.

A vehicle that may be sensed by one or more sensing vehicles may be a target vehicle. The one or more sensing vehicles may track a target vehicle. A target vehicle may be a vehicle sensed by a sensing vehicle. A target vehicle may be a vehicle sensed by multiple sensing vehicles. The target vehicle may or may not itself be a sensing vehicle. A target vehicle may be a surrounding vehicle (e.g., within a proximity of) relative to another vehicle.

A single sensing vehicle may track a target vehicle over time. Multiple sensing vehicles may each individually track the target vehicle over time. Multiple sensing vehicles may collectively track the target vehicle over time. Multiple sensing vehicles may share information that may be used to collectively track the target vehicle. For example, a first sensing vehicle may track the target vehicle. A second sensing vehicle may track the target vehicle subsequent to, or overlapping with, the first sensing vehicle tracking the target vehicle. In some instances, a target vehicle may move in and out of a detectable range of a first sensing vehicle. The second sensing vehicle may be able to detect the target vehicle while the target vehicle is out of the detectable range of the first sensing vehicle (e.g., fill in “gaps” in the tracking of the target vehicle) and/or be able to detect the target vehicle while the target vehicle is within the detectable range of the first sensing vehicle (e.g., may be used for verification of data collected by the first sensing vehicle).

Any description herein of a surrounding vehicle sensed by one or more sensing vehicles may refer to a target vehicle. A target vehicle may be in a proximity of (e.g., may be a surrounding vehicle of) a sensing vehicle. A target vehicle may be within detectable range of a sensing vehicle while sensed by the sensing vehicle.

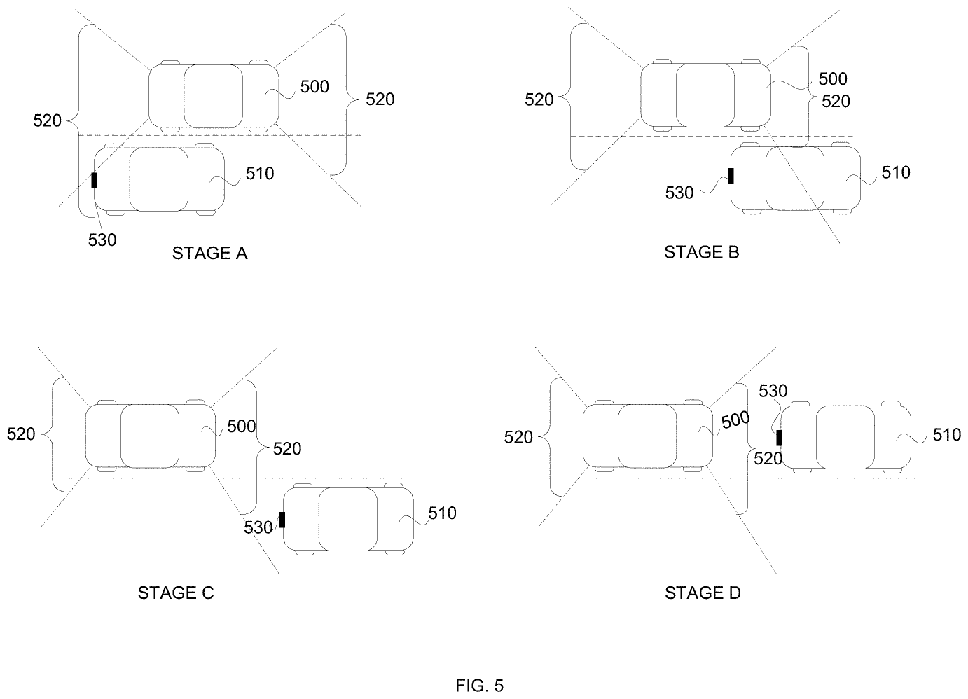

FIG. 5 shows an example of a sensing vehicle tracking a surrounding vehicle, in accordance with embodiments of the disclosure.

A sensing vehicle 500 may be traveling within an environment near a surrounding vehicle 510. The sensing vehicle may have a detectable range 520. The detectable range may substantially unchanged relative to the sensing vehicle, or may change relative to the sensing vehicle. In one example, the detectable range may include one or more regions in front of, and behind the sensing vehicle. The surrounding vehicle may pass in or out of the detectable range of the sensing vehicle. The sensing vehicle may be able to track the surrounding vehicle over time. The surrounding vehicle may be a target vehicle that is sensed and/or tracked by the sensing vehicle.

For example, at Stage A, the surrounding vehicle 510 may be passing the sensing vehicle 500. A small portion of the surrounding vehicle may be within the detectable range 520 of the sensing vehicle. The surrounding vehicle may have a vehicle identifier 530 such as a license plate that may be detectable by one or more sensors of the sensing vehicle. A license plate may be recognized with aid of one or more image sensors that may capture an image of the license plate. The image may be analyzed to read the license plate information. Optical character recognition (e.g., license plate recognition) techniques may be employed to read the license plate information. In some instances, the vehicle identifier may be outside the detectable range of the sensing vehicle.

Between Stage A and Stage B, the surrounding vehicle may pass the sensing vehicle and fall outside the detectable range of the sensing vehicle.

At Stage B, the surrounding vehicle 510 may re-enter a detectable range 520 of the sensing vehicle 500. The vehicle identifier 530 may still be outside the detectable range of the sensing vehicle. Even if the vehicle identifier is not shown, the sensing vehicle may track the surrounding vehicle and recognize the surrounding vehicle as the same surrounding vehicle between Stage A and Stage B. In some embodiments, pattern recognition/artificial intelligence may be used to recognize the surrounding vehicle. In some embodiments, neural networks, such as a convolution neural network (CNN) or recurrent (RNN) neural networks may be employed to recognize the vehicle.

In some instances, data from the one or more sensors may be analyzed to determine a likelihood that the surrounding vehicle is the same vehicle between Stage A and Stage B. Similarities or consistency in the type of information collected for the surrounding vehicle between Stage A and Stage B may be interpreted as higher likelihood that the vehicle is being recognized as the same surrounding vehicle. Significant changes or inconsistencies in the type of information collected by the surrounding vehicle between Stage A and Stage B may be interpreted as a lower likelihood that the vehicles at Stage A and B are the same surrounding vehicle. In some instances, characteristics of a surrounding vehicle may change within a predictable range or in a predictable manner. If such changes occur within the predictable range or manner, the likelihood that the vehicles at Stage A and B are the same surrounding vehicle may be higher, than if such changes occur outside the predictable range or manner.

Information from a single sensor or type of sensor may be analyzed to determine the likelihood that the vehicle is the same vehicle. Alternatively information from multiple sensors or types of sensors may be analyzed to determine the likelihood that the vehicle is the same vehicle. Information from multiple sensors may optionally be weighted. The weighted values may be factored in when analyzing whether the vehicle is the same vehicle. In some embodiments, sensor information that is determined to be more reliable may have a greater weight than sensor information that is determined to be less reliable. Sensor information that is determined to be more precise or accurate may be weighted higher than sensor information that is less precise or accurate. Sensors that have less variability in their operation may have a greater weight than sensors that have greater variability during their operation. Sensors that are configured to detect characteristics of vehicles that have lesser variability may have a greater weight than sensors that are configured to detect characteristics of vehicles that have greater variability. For example, a visual appearance of a car is less likely to change while the car is coming within or leaving the detectable range of a sensing vehicle, than a sound of the car's engine, which may change based on acceleration or deceleration.

For example, if the sensors comprise one or more cameras, the images may be analyzed to detect if the vehicle has the same physical characteristics. For example, if the vehicle has the same color, size, and shape, the likelihood that the same surrounding vehicle is being detected at Stage A and Stage B may be high. If a physical characteristic of the vehicle has changed, the likelihood that the same surrounding vehicle is being detected may be low or zero. Another example of sensors may include audio sensors. For instance, if the engine sound coming from the surrounding vehicle is substantially the same or followed the same pattern, the likelihood that the same surrounding vehicle is being detected at Stage A and Stage B may be high. If the sound has changed significantly, the likelihood that the same surrounding vehicle is being detected may be lower. Other examples of sensors may include infrared sensors. If a heat signature or pattern coming from a surrounding vehicle is substantially the same or changes in a predictable manner, the likelihood that the same surrounding vehicle is being detected at Stage A and Stage B may be high. If the heat signature or pattern has changed significantly, or changes in an unpredictable manner, the likelihood that the same surrounding vehicle is being detected at Stage A and Stage B may be lower.

Information relating to the same surrounding vehicle may be associated with one another. Regardless of whether a vehicle identifier is or is not visible, the information relating a surrounding vehicle may be stored together. In some instances, a placeholder identifier may be associated with the data about the surrounding vehicle. The placeholder identifier may be a randomized string. The placeholder identifier may be unique for each vehicle. The placeholder identifier may temporarily be used to determine that the data is associated with the same vehicle. The placeholder identifier may be an index for the information about the surrounding vehicle. When a vehicle identifier is detected for the surrounding vehicle, the vehicle identifier information may be stored with the data bout the surrounding vehicle. The vehicle identifier may be stored in the place of, or in addition to, the placeholder identifier.

A surrounding vehicle 510 may be within a detectable range of a sensing vehicle 500, as illustrated in Stage B. The vehicle identifier 530 may be outside the detectable range 520. The surrounding vehicle may move relative to the sensing vehicle. For instance, the surrounding vehicle may move forward so that the vehicle identifier comes within the detectable range, as illustrated in Stage C. Over time, a surrounding vehicle may have a vehicle identifier that moves within or outside the detectable range of the sensing vehicle. The vehicle identifier may remain outside the detectable range over time, or may remain within the detectable range over time.

As previously discussed, the surrounding vehicle may be tracked relative to the sensing vehicle. When the vehicle identifier is within a detectable range, information about the surrounding vehicle may be associated with the vehicle identifier. Any type of information about the surrounding vehicle may be associated with the vehicle identifier. For instance, information obtained by the sensing vehicle (e.g., via one or more sensors and/or communications with the surrounding vehicle) may be associated with the vehicle identifier. Examples of the information may include behavior data about the surrounding vehicle, positional information about the surrounding vehicle, or any other information about the surrounding vehicle, as described elsewhere herein.

The surrounding vehicle 510 may make further maneuvers relative to the sensing vehicle 500 as illustrated in Stage D. A vehicle identifier 530 of the surrounding vehicle may remain within a detectable range 520 of the sensing vehicle while the surrounding vehicle makes the maneuver. For example, a license plate of the surrounding vehicle may remain within range of one or more sensors on-board the sensing vehicle while the surrounding vehicle makes the maneuver.

In one example, the surrounding vehicle may change lanes. The sensing vehicle may obtain behavior data relating to the surrounding vehicle. Any description herein of obtaining behavior data may relate to obtaining any type of information relating to the surrounding behavior, as described elsewhere herein. In some instances, the surrounding vehicle may make an unsafe maneuver. For example, the surrounding vehicle may cut off the sensing vehicle. The unsafe behavior of the surrounding vehicle may be recognized and associated with the surrounding vehicle. The behavior of the surrounding vehicle, including any safe or unsafe behavior of the surrounding vehicle, may be associated with the vehicle identifier of the vehicle. The behavior of the surrounding vehicle may be stored and part of the records for that particular surrounding vehicle.

A single sensing vehicle may track a target surrounding vehicle, as illustrated. In some embodiments, multiple sensing vehicles may collaborate to track a target vehicle. The target vehicle may be a surrounding vehicle of multiple sensing vehicles. The target vehicle may come in and/or out of a detectable range of multiple sensing vehicles over time. Multiple sensing vehicles may detect and/or track a target vehicle simultaneously. Multiple sensing vehicles may detect and/or track a target vehicle sequentially or at different points in time. There may be some overlap so that multiple sensing vehicles may track a target vehicle sometimes simultaneously and sometimes at different points in time. A target vehicle may or may not be continuously tracked by at least one other vehicle. In some embodiments, the multiple sensing vehicles may track the target vehicle in a collaborative manner to plug one or more ‘holes’ when the vehicle is not being sensed. For instance, a first sensing vehicle may sense the target vehicle at some points in time, but the target vehicle may enter one or more ‘blind spots’ outside a detectable range of the first sensing vehicle. A second sensing vehicle may detect the target vehicle before, during, and/or after the target vehicle is in the blind spot of the first sensing vehicle.

The first and second sensing vehicles may share the information gathered about the target vehicle. For instance, information received by the first vehicle from the second vehicle about the target vehicle while the target is in the blind spot of the first vehicle may help the first vehicle track the target vehicle and recognize the target vehicle when the target vehicle re-enters a detectable range of the first vehicle. The first and second sensing vehicles may directly exchange information with one another. Alternatively or in addition, the first and second sensing vehicles may transit the information to a data center. The data center may receive information from a large number of sensing vehicles. The data center may or may not send some of the information to the various sensing vehicles. For instance, the data center may share some of the information gathered by a second sensing vehicle with the first sensing vehicle, or vice versa. The data center may be able to track the target vehicle using the information gathered from multiple sensing vehicles. The data center may incorporate data from the second sensing vehicle to fill in any gaps from the data in the first sensing vehicle regarding the target vehicle, and/or vice versa.

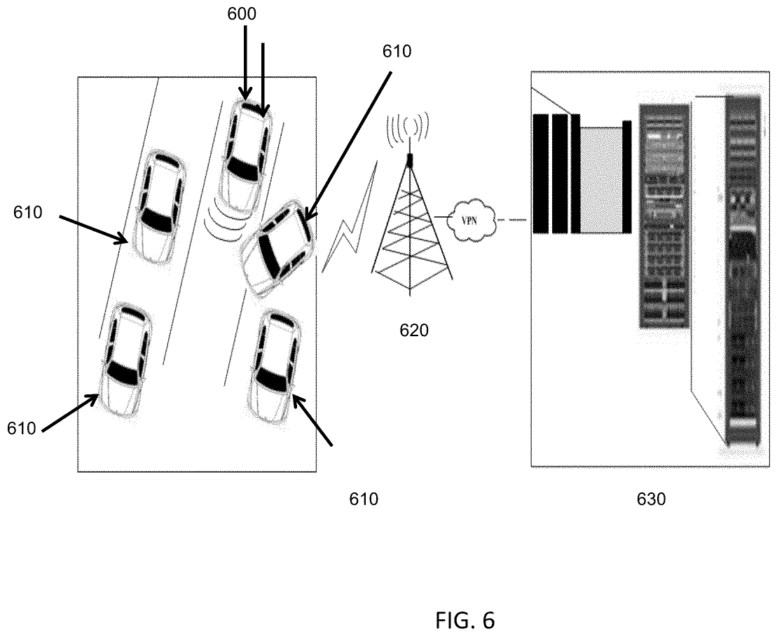

FIG. 6 shows an example of a vehicle monitoring system, in accordance with embodiments of the disclosure. The vehicle monitoring system may comprise one or more sensing vehicles 600 capable of obtaining data about one or more surrounding vehicles 610. The one or more sensing vehicles may communicate over a communication infrastructure 620 the data collected to a data center 630.

A sensing vehicle 600 may obtain data about one or more surrounding vehicles 610. Any description herein of obtaining data about one or more surrounding vehicles may include collecting behavior data about the one or more surrounding vehicles with aid of one or more sensors on-board the sensing vehicle, and vice versa. For instance, any description herein of obtaining data about one or more surrounding vehicles may include collecting behavior data via communications with the surrounding vehicle, and vice versa. Any description herein of obtaining behavior data about a surrounding vehicle may comprise collecting any type of behavior data, and vice versa. The sensing vehicle may obtain data bout one or more surrounding vehicle that is within a detectable range of the sensing vehicle.

In some embodiments, the sensing vehicle may perform pre-processing or analysis of the data obtained by the sensing vehicle on-board the sensing vehicle. The sensor may perform pre-processing or analysis with aid of an on-board analyzer. The on-board analyzer may comprise one or more processors in communication with one or more sensors on-board the sensing vehicle.

The on-board analyzer may pre-process information from one or more sensors by putting the data into a desired format. In some instances, the on-board analyzer may receive raw data from one or more sensors and convert the raw data into data of a form that may be indicative of behavior data of the one or more surrounding vehicle. The on-board analyzer may convert behavior data to positional information, such as positional information relative to the sensing vehicle, or positional information relative to an inertial reference frame. The on-board analyzer may correlate the behavior data with positional information, and/or vice versa. Different sensors may optionally output different types of data. The data may be converted to a form that may be consistent and comparable.

The on-board analyzer may optionally compare information from multiple sensors to detect how the surrounding vehicle is actually behaving. The vehicle may optionally utilize a single type of sensors. Alternatively, the vehicle may utilize multiple types of sensors. The vehicle may utilize sensor fusion techniques to determine how the surrounding vehicle is behaving. The vehicle may utilize simultaneous location and mapping (SLAM) techniques to determine how the surrounding vehicle is behaving. For instance, the sensing vehicle may utilize vision sensors and ultrasonic sensors to detect surrounding vehicles. The vision sensors may be utilized in combination with the ultrasonic sensors to determine positional information pertaining to the surrounding vehicles. Any combination of one or more, two or more, three or more, four or more, five or more, or six or more of the various types of sensors described elsewhere herein may be utilized to determine how the surrounding vehicle is behaving. In some embodiments, there may be slight inconsistencies or discrepancies in data collected by the multiple sensors.

The system may weight data from one or more sensors such that data from sensors with typically greater accuracy or precision may receive a higher weight than data from sensors with typically lesser accuracy or precision. Optionally, a confidence level may be associated with data collected by one or more sensors. When there are inconsistencies in data, there may be a lower confidence associated with the data that the data is accurate. When there are a greater number of sensors with consistent data, there may be a higher confidence associated with the data that the data is accurate, compared to when there are a fewer number of sensors with consistent data.

The on-board analyzer may or may not analyze the data obtained by the sensing vehicle. For instance, the on-board analyzer may analyze positional information about the surrounding vehicle to categorize the surrounding vehicle's behavior. The on-board analyzer may recognize various driving behaviors. The on-board analyzer may utilize pattern recognition and/or artificial intelligence to recognize various driving behaviors. In some instances, neural networks, such as CNN or RNN may be employed. The on-board analyzer may recognize safe driving behavior and unsafe driving behavior. The on-board analyzer may recognize illegal driving behavior. In some instances, illegal driving behavior may be an example of unsafe driving behavior. The on-board analyzer may recognize when a surrounding vehicle is speeding, running a red light, running a stop sign, making unsafe stops, making an illegal turn, cutting off another vehicle, not yielding right-of-way, going the wrong way on a one-way street, or getting into a collision with another vehicle, a stationary object, or a pedestrian. The on-board analyzer may optionally detect contextual information relating to a surrounding vehicle's behavior. For example, the on-board analyzer may detect whether the surrounding vehicle is making an unsafe serve for no reason, or if the swerve is necessary to avoid collision with another object. In another example, the on-board analyzer may detect whether the surrounding vehicle is illegally stopping on the side of the road, or whether the vehicle pulled over to allow an emergency vehicle to pass.

An on-board analyzer may optionally be capable of real-time modeling of the environment, detecting surrounding cars, determining whether the surrounding cars have safe or unsafe driving behaviors (e.g., illegal driving behavior), and/or generating abnormal driving behavior description information. Alternatively, any of these functions may be performed at a data center.

Alternatively, the sensing vehicle need not have an on-board analyzer. The sensing vehicle may directly transmit raw data to an off-board data center. The off-board data center may perform any of the tasks described for the on-board analyzer. In some embodiments, a sensing vehicle may have an on-board analyzer that may perform some steps relating to the data, such as some of the steps described herein. An off-board analyzer, such as a data center, may perform other steps. For example, the on-board analyzer may pre-process data, while the data-center may analyze the data to recognize behavior of the one or more surrounding vehicles. The data center may be remote to the sensing vehicle.

Optionally all data may be utilized, analyzed, stored and/or transmitted. Alternatively, data reduction techniques may be used. In some instances, only a subset of the data may be recorded at the outset. For instance, a sensing vehicle may only record data that seems interesting or relevant. A sensing vehicle may only record data that is relevant to detecting instances of unsafe or safe driving behaviors, or other categories of driving behavior, as described elsewhere herein. The sensing vehicle may only record data that may seem relevant to the other functions or applications of the vehicle monitoring system as described elsewhere herein. In some instances, the sensing vehicle may only share data that seems interesting or relevant with a data center. The sensing vehicle may or may not store all of the data, but may share only the data that seems interesting or relevant with the data center. The sensing vehicle may only transmit data to a data center that seems relevant to detecting instances of unsafe or safe driving behaviors, or other categories of behavior, as described elsewhere herein. The sensing vehicle may only transmit data that may seem relevant to the other functions or applications of the vehicle monitoring system as described elsewhere herein. This may also apply to data that may be transmitted to and/or shared with other vehicles in addition to or as an alternative to the data transmitted to the data center. The data center may record all of the data that is transmitted to the data center. Alternatively, the data center may only record a subset of the data received. For instance, a data center may only a record data that seems interesting or relevant. A data center may only record data that is relevant to detecting instances of unsafe or safe driving behaviors, or other categories of driving behavior, as described elsewhere herein. The data center may only record data that may seem relevant to the other functions or applications of the vehicle monitoring system as described elsewhere herein. In some embodiments, any duplicative information may be deemed irrelevant and need not be recorded and/or transmitted. Irrelevant data may be filtered out.

Raw data may be recorded and/or transmitted. For example, if the sensors are image sensors, the images capture by the sensors may be recorded and/or transmitted. The images may then be analyzed to detect any relevant behavior. In some instances, the data may be converted to a reduced form at the outset. For instance, a sensing vehicle may only a record the analysis of the data that is interesting or relevant. A sensing vehicle may only record descriptions of instances of unsafe or safe driving behaviors, or other categories of driving behavior, as described elsewhere herein. The descriptions may use less memory than the raw data. For instance, a label indicating “speeding” may take less memory than a still image or video clip showing the vehicle speeding. The descriptions may be stored as text or in any other format. The descriptions may include any level of specificity. For examples they may include category of behavior (e.g., speeding, running red light, unsafe merge, unsafe lane change, not stopping for stop sign, not yielding to pedestrians, etc.), time at which the behavior occurred, location at which the behavior occurred, and/or information about the vehicle performing the behavior (e.g., vehicle identifier such as license plate, color of vehicle, make of vehicle, mode of vehicle, vehicle brand, vehicle type). The sensing vehicle may only record descriptions that may seem relevant to the other functions or applications of the vehicle monitoring system as described elsewhere herein. In some instances, the sensing vehicle may only share analysis of the data that seems interesting or relevant with a data center. The sensing vehicle may or may not store all of the data, but may share only the description of the behavior that seems interesting or relevant with the data center. The sensing vehicle may only transmit descriptions to a data center that are indicative of instances of unsafe or safe driving behaviors, or other categories of behavior, as described elsewhere herein. The sensing vehicle may only transmit descriptions that may seem relevant to the other functions or applications of the vehicle monitoring system as described elsewhere herein. This may also apply to descriptions that may be transmitted to and/or shared with other vehicles in addition to or as an alternative to the descriptions transmitted to the data center. The data center may record all of the descriptions that are transmitted to the data center. Alternatively, the data center may only record a subset of the descriptions received. For instance, a data center may only a record descriptions that seems interesting or relevant. In some instances, all data may be transmitted to the data center and the data center may analyze the data to generate relevant descriptions. A data center may only record descriptions that are relevant to detecting instances of unsafe or safe driving behaviors, or other categories of driving behavior, as described elsewhere herein. The data center may only record descriptions that may seem relevant to the other functions or applications of the vehicle monitoring system as described elsewhere herein.

The sensing vehicle 600 may communicate with a data center 630 with aid of communication infrastructure 620. The sensing vehicle may communicate with the data center wirelessly. A wireless communication may include data from the sensing vehicle to the data center and/or data from the data center to the sensing vehicle. In some embodiments, one-way communication may be provided. For example, data about one or more surrounding vehicles obtained by the sensing vehicle may be communicated to the data center. Optionally, communications from the sensing vehicle to the data center may comprise data about the sensing vehicle itself, a driver of the sensing vehicle, and/or a driver of the surrounding vehicle. The communications may or may not include analyzed behavior data of the surrounding vehicle and/or the sensing vehicle. In some embodiments, two-way communication may be provided. For example, data obtained by the sensing vehicle may be sent from the sensing vehicle to the data center, and data from the data center may be sent to the sensing vehicles. Examples of data from the data center may include, but are not limited to, data about the one or more surrounding vehicles, data about one or more environmental conditions (e.g., weather, traffic, accidents, road conditions), or commands that affect operation of the sensing vehicle (e.g., driver's assistance, autonomous or semi-autonomous driving).

The communication between the sensing vehicle and the data center may be a direct communication. A direct communication link may be established between the sensing vehicle and the data center. The direct communication link may remain in place while the sensing vehicle is in motion. The data center may be stationary or in motion. The sensing vehicle may be moving independently of the data center. Any type of direct communication may be established between the sensing vehicle and the data center. For example, WiFi, WiMax, COFDM, Bluetooth, IR signals, or any other type of direct communication may be employed. Any form of communication that occurs directly between two objects may be used or considered.

In some instances, direct communications may be limited by distance. Direct communications may be limited by line of sight, or obstructions. Direct communications may permit fast transfer of data, or a large bandwidth of data compared to indirect communications.

The communication between the sensing vehicle and the data center may be an indirect communication. Indirect communications may occur between the sensing vehicle and the data center with aid of one or more intermediary devices. In some examples the intermediary device may be a satellite, router, tower, relay device, or any other type of device. Communication links may be formed between a sensing vehicle and the intermediary device and communication links may be formed between the intermediary device and the data center. Any number of intermediary devices may be provided, which may communicate with one another. In some instances, indirect communications may occur over a network, such as a local area network (LAN) or wide area network (WAN), such as the Internet. In some instances, indirect communications may occur over a cellular network, data network, or any type of telecommunications network (e.g., 3G, 4G, LTE). A cloud computing environment may be employed for indirect communications.

In some instances, indirect communications may be unlimited by distance, or may provide a larger distance range than direct communications. Indirect communications may be unlimited or less limited by line of sight or obstructions. In some instances, indirect communications may use one or more relay device to aid in direct communications. Examples of relay devices may include, but are not limited to satellites, routers, towers, relay stations, or any other type of relay device.

A method for providing communications between a sensing vehicle and a data center may be provided, where the communication may occur via an indirect communication method. The indirect communication method may comprise communication via a mobile phone network, such as a LTE, 3G or 4G mobile phone network. The indirect communications may use one or more intermediary devices in communications between the sensing vehicle and the data center. The indirect communication may occur when the sensing vehicle is in motion.

Any combination of direct and/or indirect communications may occur between different objects. In one example, all communications may be direct communications. In another example, all communications may be indirect communications. Any of the communication links described and/or illustrated may direct communication links or indirect communication links. In some implementations, switching between direct and indirect communications may occur. For example, communication between a sensing vehicle and a data center may be direct communication, indirect communication, or switching between different communication modes may occur. Communication between any of the devices described (e.g., vehicle, data center) and an intermediary device (e.g., satellite, tower, router, relay device, central server, computer, tablet, smartphone, or any other device having a processor and memory) may be direct communication, indirect communication, or switching between different communication modes may occur.

In some instances, the switching between communication modes may be made automatically without requiring human intervention. One or more processors may be used to determine to switch between an indirect and direct communication method. For example, if quality of a particular mode deteriorates, the system may switch to a different mode of communication. The one or more processors may be on board the sensing vehicle, part of a data center, on board a third external device, or any combination thereof. The determination to switch modes may be provided from the sensing vehicle, the data center, and/or a third external device.

In some instances, a preferable mode of communication may be provided. If the preferable mode of communication is inoperational or lacking in quality or reliability, then a switch may be made to another mode of communication. The preferable mode may be pinged to determine when a switch can be made back to the preferable mode of communication. In one example, direct communication may be a preferable mode of communication. However, if the sensing vehicle drives too far away, or obstructions are provided between the sensing vehicle and the data center, the communications may switch to an indirect mode of communications. In some instances, direct communications may be preferable when a large amount of data is transferred between the sensing vehicle and the data center. In another example, an indirect mode of communication may be a preferable mode of communication. If the sensing vehicle and/or data center needs to quickly transmit a large amount of data, the communications may switch to a direct mode of communications. In some instances, indirect communications may be preferable when the sensing vehicle at significant distances away from the data center and greater reliability of communication may be desired.

Switching between communication modes may occur in response to a command. The command may be provided by a user. The user may be an operator and/or passenger of the sensing vehicle. The user may be an individual at a data center or operating a data center.

In some instances, different communication modes may be used for different types of communications between the sensing vehicle and the data center. Different communication modes may be used simultaneously to transmit different types of data.

The data center 630 may receive and store information collected by the sensing vehicle. As described elsewhere herein, the data center may comprise one or more processors that may receive and store information. The data center may receive and store information collected by multiple sensing vehicles. The data center may receive and store information regarding one or more surrounding vehicles collected by the multiple sensing vehicles. The data center may receive information directly from the sensing vehicle or vehicles, or may receive the information indirectly from the sensing vehicle or vehicles. The data center may receive the information with aid of a communication infrastructure 620. In one example, a virtual private network (VPN) may be utilized in providing the information to a data center.

The data center may receive any information obtained by one or more sensing vehicles. The information may include obtained about one or more surrounding vehicles, the sensing vehicle itself, or an environment around the sensing vehicle. The information may include information about a driver or any other individual associated with the one or more surrounding vehicles and/or the sensing vehicle. The information may include a driver identifier and/or vehicle identifier of the sensing vehicle or the one or more surrounding vehicles. Any information described elsewhere herein may be included.

The data center may receive and/or provide context or circumstances at which the information is obtained. For example, the data center may receive contextual information, such as time or location information at which the information was collected. For example, a sensing vehicle may provide a time at which data about the surrounding vehicle was collected. The time may be provided in any format. For instance, the time may be provided in hours, minutes, seconds, tenths of seconds, hundredths of seconds, and/or milliseconds. The time may include a day of the week, date (e.g., month, day of the month, year). The time may include time zone information (e.g., whether the information was collected at Eastern Standard time, Coordinated Universal time, etc.). The time may be provided as a time stamp. The time stamp may be provided based on a time keeping device (clock) on-board the sensing vehicle. The time stamp may be provided based on a time keeping device off-board the sensing vehicle, such as a satellite, server, the surrounding vehicle, data center, or any other reference device.

Similarly, a sensing vehicle may provide a location at which data about the surrounding vehicle was collected. The location may include a location of the surrounding vehicle relative to the sensing vehicle and/or relative to an inertial reference frame. Alternatively or in addition, the location may include a location of the sensing vehicle. The location of the sensing vehicle may be within an inertial reference frame or relative to any reference point. The location may be provided in any format. For instance, the location may be provided as geospatial coordinates. The coordinates may be relative to an inertial reference frame, such as latitude, longitude, and/or altitude. Examples of coordinates systems may include, but are not limited to, Universal Transverse Mercator (UTM), Military Grid Reference System (MGRS), United States National Grid (USNG), Global Area Reference System (GARS), and/or World Geographic Reference System (GEOREF). The location may be provided as distance and/or direction relative to a reference point, such as a sensing vehicle.

The contextual information, such as time and/or location, may be gathered by the sensing vehicle when the sensing vehicle obtains the information. The contextual information may be provided a surrounding vehicle when the surrounding vehicle communicates with the sensing vehicle. The contextual information may be provided by a sensing vehicle when the sensing vehicle sends information to the data center. The contextual information may be provided by the data center when the data center receives information from the sensing vehicle.

Additional examples of contextual information may include, but are not limited to, environmental conditions, such as weather, precipitation, traffic, known accidents, local events (e.g., street fairs, etc.), power blackouts, or original source of information (e.g., sensor on-board sensing vehicle, identity of surrounding vehicle, external sensors), or any other type of contextual information.

For example, the data center may provide a time stamp, or any other type of time information, when the data center receives information from the sensing vehicle. The sensing vehicle may provide information to the data center in substantially real-time as the sensing device has obtained the data about the one or more surrounding vehicles, and/or data about the sensing vehicle. For instance, the sensing device may transmit information to the data center within half an hour, 15 minutes, 5 minutes, 3 minutes, 2 minutes, 1 minute, 30 seconds, 15 seconds, 10 seconds, 5 seconds, 3 seconds, 2 seconds, 1 second, 0.5 seconds, 0.1 seconds, 0.05 seconds, 0.01 seconds, or 0.001 seconds of obtaining the data bout the one or more surrounding vehicles and/or sensing vehicle (e.g., with aid of one or more sensors, and/or communications with the one or more surrounding vehicles).

The sensing vehicle may provide information to the data center while the sensing vehicle is in operation. The sensing vehicle may provide information while the sensing vehicle is powered on. In some instances, the sensing vehicle may provide information for substantially an entire period that the sensing vehicle is powered on. The sensing vehicle may provide information while the sensing vehicle is in motion. In some instances, the sensing vehicle may provide information for substantially an entire period that the sensing vehicle is in motion. In some instances, the sensing vehicle may provide information substantially continuously, at predetermined time intervals, or in response to one or more events. For example, the sensing vehicle may provide information only when the sensing vehicle has pre-analyzed the information and detected unsafe driving behavior.

The data center may aggregate information received by the one or more sensing vehicles. The data center may associate and/or index information by any aspect of the information, (e.g., behavior data of the surrounding vehicle, surrounding vehicle identity, surrounding vehicle driver identity, sensing vehicle identity, sensing vehicle driver identity, or contextual information).

The data center may analyze the information received from the one or more sensing vehicles. The data center may recognize patterns or behavior over time. The data center may be able to generate a safe driving index for one or more vehicles. The data center may be able to generate a safe driving index for one or more drivers. The safe driving index for the one or more vehicles may be provided on a vehicle by vehicle basis without regard to the identity of a driver of the vehicle. The safe driving index for one or more drivers may be provided on a person by person basis without regard to the identity of an identity of the vehicle driven by the driver. In other instances, the safe driving index may take into account both driver identity and vehicle identity (e.g., Person A seems to drive more safely with Vehicle A than Vehicle B, etc.).

The data center may comprise one or more computing devices. For example, the data center may comprise one or more servers, personal computers, mobile devices (e.g., smartphones, tablets, personal digital assistants), or any other type of device. In some examples, the data center may comprise one or more servers and/or databases. The data center may be provided at a single location or at multiple locations. The data center may be owned, controlled, and/or operated by a single entity. Alternatively, the data center may be owned, controlled, and/or operated by multiple entities. Any description herein of a function of the data center may be performed by a single device or multiple devices acting in concert. Any description herein of a data center may be performed a single location individually or multiple locations collectively. The data center may comprise one or more memory storage devices which may comprise non-transitory computer readable media that may comprise code, logic, or instructions, for performing one or more steps provided herein. The data center may comprise one or more processors which may execute code, logic or instructions to perform the one or more steps provided herein.

In alternative embodiments, any function of the data center may be performed by multiple objects. In some instances, any function of the data center may be performed by a cloud computing or peer-to-peer architecture. In one example, each sensing vehicle may comprise an on-board analyzer, and the various sensing vehicles may communicate and share information with one another.

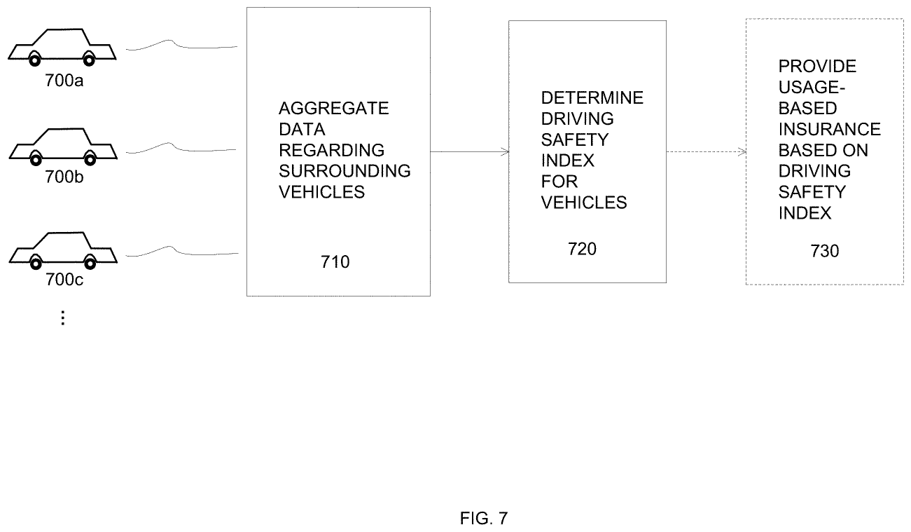

FIG. 7 illustrates data aggregation and analysis from one or more sensing vehicles, in accordance with embodiments of the disclosure. One or more sensing vehicles 700a, 700b, 700c may provide information obtained by the one or more sensing vehicles. The information may be received by a data center. The data center may aggregate information received by the one or more sensing vehicles, such as data regarding surrounding vehicles 710. The data center may determine a safe driving index for the vehicles 720. Optionally, usage-based insurance (UBI) may be provided based on the safe driving index 730.

One or more sensing vehicles 700a, 700b, 700c may obtain information about one or more surrounding vehicles and/or the sensing vehicle itself. Any description herein of obtaining and/or analyzing information relating to the one or more surrounding vehicles may also apply to the sensing vehicle itself. The sensing vehicle may obtain information about the one or more surrounding vehicles with aid of one or more sensors and/or communications with the respective surrounding vehicle. Any description provided elsewhere herein of sensing vehicles and collection of data may apply. A single sensing vehicle may provide information. Alternatively, multiple sensing vehicles may provide information.

Information received from the one or more sensing vehicles may be aggregated 710. Information from a single sensing vehicle collected over time may be aggregated. Information from multiple sensing vehicles may be aggregated. Data regarding one or more surrounding vehicles of the various sensing vehicles may be aggregated. Any description herein of the data regarding the one or more surrounding vehicles may also apply to any other information obtained from the one or more sensing vehicles, such as data about the sensing vehicles themselves, or environmental conditions, and vice versa.

As previously described, data may be collected by multiple sensing vehicles. The data may be collected and/or transmitted simultaneously. The data may be collected and transmitted over a period of time. The data collected by the multiple sensing vehicles may or may not overlap. For example a first vehicle 700a and a second vehicle 700b may be driving within a same region at approximately the same period of time. The same surrounding vehicles may be detected by the both the first vehicle and the second vehicle. For example the first vehicle and the second vehicle may both collect information about Vehicle A, Vehicle B and Vehicle C. Vehicles A, B, and C may be near both the first and second vehicles. The information about the vehicles may or may not overlap. For instance, the first vehicle may collect information about Vehicle A at exactly the same time that the second vehicle collects information about Vehicle A.

If the information provided by the first and second vehicles are consistent, this may increase the likelihood that the information obtained about Vehicle A at that moment in time is accurate. Data about the multiple sensing vehicles may or may not be stored with a corresponding confidence level. If the data is consistent, the confidence level may be high. If the data is inconsistent, then the confidence level may be lower. In some instances, over time, the system may be able to detect when particular sensing vehicles are regularly providing inconsistent data relative to other vehicles. If that is the case, the data from the aberrant sensing vehicle may be discounted or provided less weight. In some instances, the data from the aberrant sensing vehicle may be ignored altogether.

In some instances, when the first and second vehicles are in the same area at the same time, they may collect information about one another. For example, the second vehicle may be a surrounding vehicle of the first vehicle and vice versa. The first vehicle may collect information about the second vehicle (e.g., with aid of one or more sensors). The second vehicle may or may not collect information about the first vehicle while the first vehicle is collecting information about the second vehicle. In some instances, this may occur when the second vehicle is within a detectable range of the first vehicle, but the first vehicle is not within a detectable range of the second vehicle. This may be due to placement of the vehicles relative to one another or different detection ranges of the first vehicle and the second vehicle.

In some instances, the data collected by some of the sensing vehicle do not overlap. For example a first vehicle 700a and a third vehicle 700c may be driving within a different region or at the same region at different times. Different surrounding vehicles may be detected by the first vehicle and the third vehicle. For example the first vehicle may collect information about Vehicles A and B, while the third vehicle may collect information about vehicles C and D. Optionally, the first vehicle may collect information about Vehicle A at a first period in time, and the third vehicle may collect information about Vehicle A at a second period in time different from the first period in time. The first vehicle may not detect the third vehicle and the third vehicle may not detect the first vehicle.

The data may be aggregated. As previously described, the data may be indexed and/or associated according to any aspect of the information. The aggregated data may be associated with a vehicle identifier for the vehicle that the data is regarding. For instance, a first vehicle may collect information about surrounding Vehicle A, which may be stored and associated with a vehicle identifier for Vehicle A. A second vehicle may also collect information about surrounding Vehicle A, which may be stored with and associated with the vehicle identifier for Vehicle A. In another example, a third sensing vehicle may be Vehicle A and may provide information about itself, such as its location, or forces experienced by it, and may be associated with its vehicle identifier. Thus, all the data collected over time for various sources relating to a particular vehicle identifier may be accessed and/or analyzed together. The information collected by the first vehicle, second vehicle, and/or the third vehicle may or may not overlap. Duplicate data may or may not be removed. Data with slight inconsistencies may be averaged, or all sets of data may be stored.

A safe driving index may be determined for a particular vehicle. The safe driving index may be associated with the vehicle identifier of the vehicle. In some instances, all of the aggregated data for a particular vehicle (e.g., associated with the vehicle identifier) may be analyzed to generate the safe driving index. This may include all data collected by all sensing vehicles over the entirety of the period of time that the data was collected and stored. Alternatively, a subset of the aggregated data for the vehicle may be analyzed to generate the safe driving index for that vehicle. For example, the data from only a selected period of time may be analyzed and used to generate the safe driving index for that vehicle. This may include a most recent selected period of time (e.g., within the past day, within the past week, within the past month, within the past quarter, within the past year, within the past several years, within the past decade). The subset of data may include only data from particular sources or that exceed a particular confidence level. For instance, only data that exceeds a confidence level of 40% or greater, 50% or greater, 60% or greater, 70% or greater, 80% or greater, 90% or greater, 95% or greater, 97% or greater, 99% or greater, or 99.5% or greater may be used to generate the safe driving index.

The safe driving index for a particular vehicle may be based on data provided by that vehicle, may be based on data provided by one or more other vehicles, or may be based on a combination of data provided by that vehicle and one or more other vehicles. For example, a safe driving index for a sensing vehicle may be determined based on data provided by the sensing vehicle, one or more surrounding vehicles, or both the sensing vehicle and one or more surrounding vehicles. A safe driving index for a specified surrounding vehicle may be determined based on data provided by the specified surrounding vehicle, one or more other sensing vehicles surrounding the specified surrounding vehicle, or a combination of both. The data collected by a vehicle may include data collected by the vehicle based on one or more sensors on-board the vehicle, a device carried on-board the vehicle (e.g., by a passenger, which may include a driver), and/or communications between the vehicle and an external object such as another vehicle.

The safe driving index may be a qualitative or quantitative indicative of how safely a vehicle is operating. Unsafe and safe behaviors may be considered. In some embodiments, unsafe driving behaviors may be detected for a particular vehicle. The unsafe behavior may ‘lower’ a safe driving index. Thus, detected unsafe behavior may indicate that the vehicle does not operate as safely. The degree to which the safe driving index is lowered may be the same regardless of the type of unsafe behavior. Alternatively, the degree to which the safe driving index is lowered may vary depending on the type of unsafe behavior. For example, behaviors that may be more unsafe may cause the safe driving index to be lowered by a greater amount. For example, getting into an accident (e.g., a collision) with another vehicle may lower the safe driving index by more than cutting off a driver without getting into an accident. The degree to which the safe driving index is lowered may depend on a confidence level associated with the unsafe behavior. For instance, if multiple vehicles corroborate that a particular vehicle performed an unsafe maneuver, the safe driving index may be lowered more than when a single vehicle detects potential unsafe behavior, when that single vehicle has shown that its information is often not consistent with other vehicles.

Unsafe driving behavior may include illegal driving behavior (e.g., driving behavior that violates a law or rule of a jurisdiction within which the vehicle is operating) and/or legal driving behavior that may still be deemed to pose a safety risk. Examples of unsafe driving behavior may include, but are not limited to, speeding (e.g., going over a legal speed limit, or a suggested posted speed limit), running a red light, running a stop sign, not yielding when the vehicle should yield (e.g., to other vehicles, pedestrians), unsafe lane changes or merges (e.g., cutting off other vehicles), stopping in the middle of the road, going outside the lane markers, not stopping for pedestrians, making illegal turns (e.g., right, left, or u-turns when it is unsafe or illegal to do so), driving over curbs or medians, frequent harsh braking, frequent hydroplaning, carpool violations, not paying tolls, broken tail light, and/or collisions (e.g., with other vehicles, stationary objects, pedestrians, or animals). In some instances, contextual information may be used to determine whether these behaviors are particularly unsafe or whether they were necessary for safe driving under the circumstances. For example, it may be unsafe to brake suddenly and harshly in the middle of the road, but it may be safe or necessary when a deer runs across the street.

Safe behavior may ‘increase’ a safe driving index. Thus, safe behavior shown over time may show that the vehicle has a tendency to operate safely. The degree to which the safe driving index is increased may be the same regardless of the type of safe behavior. An amount to which the safe driving index is increased may directly correlate to an amount (e.g., length of time, distance) of driving that is performed safely. In some instances, there may be different types of safe behavior, and the degree to which the safe driving index is increased may depend on the type of safe behavior, or a confidence level associated with the data collected that indicated the safe behavior.

Various aspects of driving behavior may be analyzed to determine whether the behavior is safe or unsafe. For example, lane changing behavior may be analyzed. Lane changing behavior may be safe or unsafe based on its context (e.g., may be unsafe to cut-off a vehicle, may be safe if there is plenty of room, or is necessary to avoid an accident). Other examples of aspects of behaviors may include, but are not limited to, speed, sudden stops/brakes, sudden acceleration, accidents (e.g., accidents where driver is at fault vs accidents that were unavoidable and steps were taken to minimize the damage), turns, and so forth. A scrapes index may be generated in addition or alternatively to the safe driving index. A scrapes index may relate to accidents that may occur.

In some embodiments, safe behavior may maintain a safe driving index. For instance, if a vehicle performs a safe driving maneuver, the safe driving index for the vehicle may remain the same. In some embodiments, a safe driving index may start at a maximum for a vehicle, and may only be lowered when an unsafe driving behavior is performed. The safe driving index may subsequently remain at the lowered level, or may be increased back to the original maximum level if the driver does not perform any more unsafe maneuvers for a particular amount of driving or length of time. In another example, a safe driving index may start at a moderate level for a vehicle. The safe driving index may be increased when the driver operates the vehicle safely for a particular amount of driving or length of time, and the safe driving index may be decreased when the driver operates the vehicle in an unsafe manner.

Safe behavior may include any behavior that is considered safe, or that is not considered unsafe. Safe behavior may include maneuvers that would prevent an accident from occurring or reduce the likelihood of an accident occurring. Safe behavior may include maneuvers that may reduce the severity of an accident. Safe behavior may legal driving behavior. Safe behavior may include any behavior that does not increase the likelihood of an accident occurring.

A safe driving index may be a quantitative indicator of how safely a vehicle tends to behave. For example, the safe driving index may be a numerical value. In one example, the numerical value may range between a minimum value and a maximum value (e.g., between 1 and 10, or between 0 and 100). The numerical value may be only a whole number, or may include decimals. Alternatively, there may be no minimum and/or maximum. For example, as a vehicle drives safely over a long period of time, the safe driving index may just continue to increase without limit. If a driver drive unsafely over a long period of time, the driving safety index may continue to decrease without limit. A higher numerical value may indicate that a driver is a safer driver than a lower numerical value. Alternatively, the numerical value may indicate a degree of risk so that a driver that is a safer driver may have a lower numerical value. Any discussion herein of a ‘higher’ or ‘lower’ driving safety index may mean that a ‘higher’ index correlates with a safer driver, rather than the numerical value, although a higher numerical value may correlate to a safer driver in some instances.

A safe driving index may be a qualitative indicator how safely a vehicle tends to behave. For example, the safe driving index may fall within a plurality of categories. Any number of categories may be provided. For example, the categories may be letters. For instance, an ‘A’ vehicle may represent a very safe vehicle while an ‘E’ vehicle may represent a relatively unsafe vehicle. In another example, categories may include ‘safe vehicle’, ‘moderately safe vehicle’, ‘moderate vehicle’, ‘moderately unsafe vehicle’, and/or ‘unsafe vehicle.’ In some instances, the categories may relate to the type of unsafe driving behavior that the vehicle tends to exhibit. For example, the categories may include ‘speeder’, ‘accident-prone’, ‘ignores traffic lights’, or other types of categories. In some instances, categories may relate to general types of driving behavior and the driving safety index may be an aggregate of how the vehicle behaves in all of the categories, or the categories may be considered independently. For example, driving categories may include speed, swerves, stops, acceleration, and/or accidents. A driving safety index may be provided for each of these categories depending on driver behavior (e.g., one vehicle may rate a 100 on speed, 90 on swerves, 90 on stops, 30 on acceleration, and 80 on accidents, if the driver is a relatively safe driver in all of these categories except tends to accelerate suddenly).

The safe driving index associated with the various vehicles may be useful for many further functions or services. For example, UBI may be provided for the vehicles. The vehicle insurance may be provided based on how the vehicle behaves. For instance, the vehicle insurance may depend on how safely a vehicle tends to operate. The vehicle insurance may depend on the safe driving index for that vehicle.

For example, a UBI company may decide whether to offer insurance or not to the vehicle depending on the safe driving index for that vehicle. If the safe driving index does not exceed a particular threshold, the UBI may not offer any insurance for that vehicle. In some instances, the UBI may offer insurance but the terms of the insurance may depend on the safe driving index. For example, for higher safe driving indexes for a particular vehicle, the UBI may offer cheaper rates for particular levels of coverage. Or they may offer a more comprehensive level of coverage. By contrast, for lower safe driving indexes for a particular vehicle, the UBI may require higher rates for particular levels of coverage. Or they may offer a less comprehensive level of coverage. There may be different categories of insurance packages that may be offered to the vehicles based on their safe driving index. For instance, depending on the safe driving index, the vehicle may fall into one or more categories of available insurance packages. Alternatively or in addition, each insurance offering may be personalized to the vehicle based on the safe driving index about the vehicle or any other information about the vehicle. Other information about the vehicle, such as vehicle model, make, color, location, commute length, commute frequency, or driver history, may be considered in formulating the insurance package.

The UBI may automatically formulate the insurance package based on the safe driving index and/or other factors. The UBI may automatically formulate the package with aid of one or more processors. Alternatively, a human operator may aid in the formulation of the package. The data center may provide information to a UBI system. For instance, the data center may provide the safe driving index to a UBI system. The data center may or may not provide any other information about the vehicle or behavior data of the vehicle to the UBI system. The UBI system may comprise one or more servers and/or computing devices. The UBI system may have any characteristics of the data center as described elsewhere herein.

The safe driving index or any other behavior information associated with the vehicle may be useful for other applications in addition to UBI. For instance, they may be useful for providing driver's assistance or autonomous or semi-autonomous driving functions. Additionally or alternatively, they may be useful for general traffic monitoring functions. The systems and methods provided herein may provide moving traffic monitoring and need not be limited to cameras installed at road junctions.

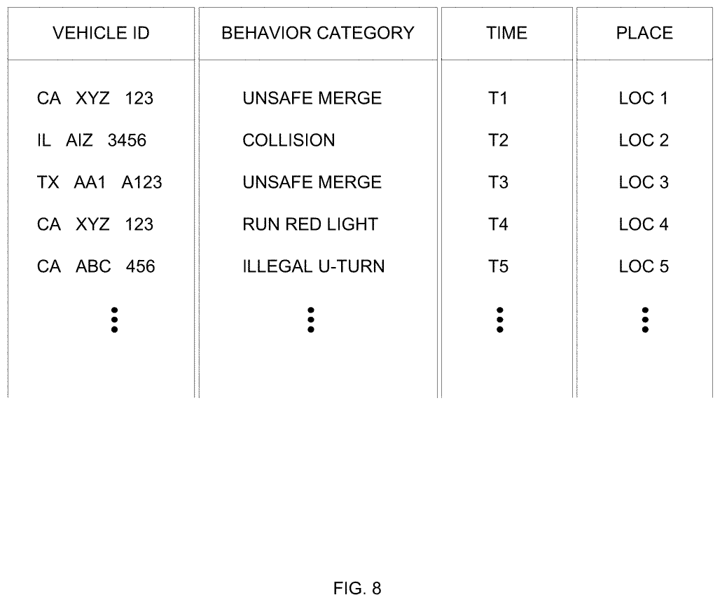

FIG. 8 illustrates data that may be collected from one or more sensing vehicles, in accordance with embodiments of the disclosure. As previously described various types of information may be collected and aggregated and/or stored. The information obtained by a particular sensing vehicle may or may not be aggregated and/or stored on-board the sensing vehicle itself. In some instances, a subset of the information obtained may be aggregated and/or stored on-board the sensing vehicle (e.g., within a particular period of time, etc.).

Alternatively or in addition, the information obtained by a sensing vehicle and/or other sensing vehicles may be aggregated and/or stored at a data center. The data center may receive information from multiple sensing vehicles. The information from the multiple sensing vehicles and/or other sensing vehicles may be stored and/or aggregated at the data center. Any description herein of the information stored may apply to information stored on-board the sensing vehicle, other sensing vehicles, at the data center, on a separate storage medium, or any combination thereof.

In some instances, identifying information, behavior information, and/or contextual information may be stored and/or associated with another. For example, information may be stored as a vehicle identifier+behavior data+time+location.

Examples of vehicle identifiers may include vehicle license plate information (as shown in FIG. 8), vehicle identification numbers (VIN), randomly generated unique identifiers, or any other type of identifying information for a vehicle, as described elsewhere herein. Vehicle identifiers may comprise unique identification information about the one or more corresponding vehicles. The unique identification information may be discernible from outside the one or more corresponding vehicles. For instance, the unique identification information may be visibly discernible from outside the one or more corresponding vehicles. The unique identification information may be discernible with aid of a heat sensor, audio sensor, any other type of radiation sensor, radiofrequency reader, or other types of sensors. A sensing vehicle may comprise one or more sensors that collect data that determines the one or more corresponding vehicle identifiers.

The behavior data may include any level of specificity relating to the behavior of the vehicle. For example, behavior categories may be provided that may be indicative of the type of behavior detected for the vehicle. In some instances, only unsafe behavior categories are provided and/or stored. Alternatively or in addition, one or more safe behavior categories or details may be provided and/or stored. The behavior data may include specific details about the behavior data. For example, in addition to merely identifying that a vehicle ran a red light, the behavior data may specify the location of the red light, how fast the vehicle was going, the direction the vehicle was traveling, whether there were any other vehicles in the intersection, or any other information associated with the driving behavior. The behavior data may include location data for the one or more surrounding vehicles.

The contextual information may include time and location information. The time may be a time at which the behavior data was collected. The location may be a location of the vehicle performing the behavior data, or a location of the sensing vehicle obtaining information about the behavior data. The contextual information may be any other type of information, as described elsewhere herein.

The vehicle identifiers may be used to determine whether the various entries are associated with a particular vehicle. For example, CA XYZ 123 shows up multiple times, which indicates that the associated behavior was performed by the same vehicle. For example, CA XYZ 123 both performed an unsafe merge at time T1 at location LOC1, and ran a red light at time T4 and location LOC 4. Information about behaviors about the other vehicles (e.g., IL A12 3456, TX AA1 A123, CA ABC 456) may be stored and accessible.

Alternatively or in addition, information about the source of the information (e.g., sensing vehicle that provided the information, sensors that collected the information, surrounding vehicle that communicated the information) may be stored. Additional information, such as environmental conditions, and/or driver (of the surrounding vehicle or the sensing vehicle) information, may be stored.

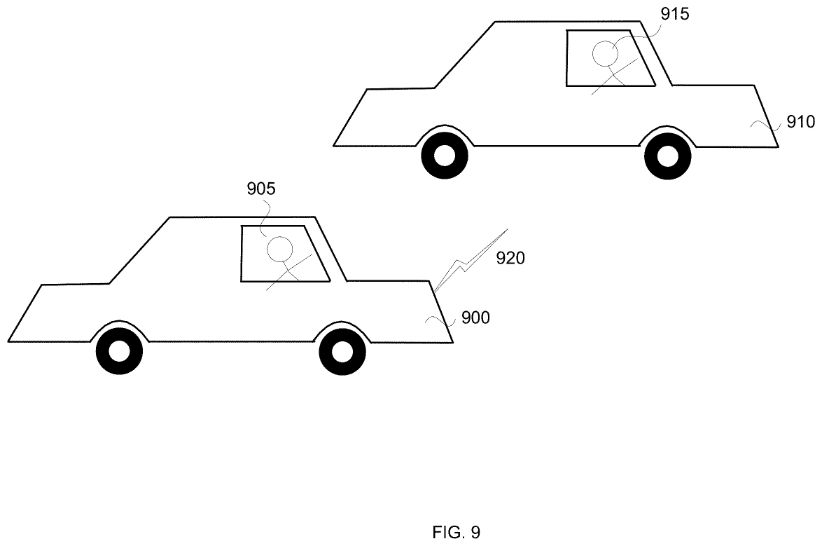

FIG. 9 shows an example of driver identification, in accordance with embodiments of the disclosure. A sensing vehicle 900 may be capable of detecting one or more surrounding vehicles 910. The sensing vehicle may be capable of obtaining information about the one or more surrounding vehicles, such as any types of information as described elsewhere herein. For example, the sensing vehicle may be capable of obtaining vehicle identification information of a surrounding vehicle. The sensing vehicle may be capable of obtaining identification of an individual associated with the surrounding vehicle.

An individual associated with the surrounding vehicle may be an owner or operator of the surrounding vehicle. An individual associated with the surrounding vehicle may be a passenger of the surrounding vehicle. The individual associated with the surrounding vehicle may be a driver 915 of the surrounding vehicle. An individual associated with the surrounding vehicle may be a family member of an owner or operator of the surrounding vehicle. An individual associated with the surrounding vehicle may be any individual listed as being associated with the surrounding vehicle. The individual associated with the surrounding vehicle may optionally be pre-registered with the vehicle. Any description herein of a driver of the vehicle may refer to any type of individual associated with the surrounding vehicle, and vice versa.

Any information about an individual associated with the surrounding vehicle may be collected. For example, an individual's name, an identifier associated with the individual, address, contact information, driver's license information, criminal history, driving history, previous accidents, insurance information, age, medical conditions, social security number, and/or other information for the individual may be accessed.

In some embodiments, the sensing vehicle 900 may obtain information about a driver 915 of the surrounding vehicle 910 with aid of one or more sensors on-board the sensing vehicle. The driver may be within a detectable range of the one or more sensors. For example, the one or more sensors may comprise image sensors that may capture an image of the surrounding vehicle and/or driver of the surrounding vehicle. In some embodiments, a face of the driver may be captured with aid of one or more image sensors. Facial recognition algorithms may be utilized to identify the driver of the vehicle. In some instances, the face may be compared against a large database of individuals with stored facial recognition information. In other instances, the face may be compared against a smaller subset of individuals with stored facial information. The smaller subset of individuals may comprise individuals associated with the surrounding vehicle. The smaller subset of individuals may comprise family members of individuals associated with the surrounding vehicle.

Any other type of sensor may be employed to recognize a driver of the vehicle. In some embodiments, audio sensors may be used to capture a sound of the driver's voice. Voice recognition protocols may be similarly used to identify the driver. In another example, infrared sensors may be used to detect one or more heat signatures associated with the driver. Various types of sensors may collect information associated with the driver. The collected information may be compared to known information about various individuals to attempt to identify the driver.

In some embodiments, the sensing vehicle 900 may obtain information about a driver 915 of the surrounding vehicle 910 based on communication between the sensing vehicle and the surrounding vehicle, or an object carried within the surrounding vehicle.

A surrounding vehicle 910 may be capable of identifying a driver 915 of the surrounding vehicle. Optionally, a sensing vehicle 900 may be capable of identifying a driver 905 of the sensing vehicle. Any description of identifying the driver of the surrounding vehicle may also apply to identifying the driver of the sensing vehicle, and vice versa.

A driver identifier may uniquely identify a particular driver. The driver identifier may comprise a name of a driver (e.g., full legal name). The driver identifier may comprise a social security number, passport number, birth date, randomized string, biometric information (e.g., fingerprint information, facial recognition information, retinal scan information, handprint information, DNA information, gait information) or any other type of unique information for a particular driver. The driver identifier may be based on discernible information about the information with aid of one or more sensors external to a vehicle that a driver is operating. One or more sensors on-board a sensing vehicle may be capable of collecting data that determines a corresponding driver identifier.

The surrounding vehicle may identify the driver of the surrounding vehicle based on a default setting. For example, the surrounding vehicle may have an associated driver that remains as the default setting unless changed. For example, if John Smith is associated as the driver of the surrounding vehicle, then the surrounding vehicle may communicate that John Smith is the driver unless a change is made to the setting. A change of identity may be manually made. For example, his wife, Mary Smith may update the settings so that she is the associated driver of the vehicle. The change of identity may be manually made from the vehicle (e.g., one or more buttons of the vehicle, at a vehicle screen or terminal, etc.) or may be made remotely from the vehicle (e.g., with aid of a mobile device or computing device that may send commands that update the settings of the surrounding vehicle).

The surrounding vehicle may identify the driver of the surrounding vehicle based on an object carried by or worn by the driver. For example, the driver may have a set of keys for the vehicle. The set of keys may be associated with the driver of the vehicle. For example, if John Smith and his wife Mary Smith own the vehicle, they may each have their own set of keys. John Smith's keys may identify John, while Mary Smith's keys may identify Mary. When John uses his keys to open the vehicle, or utilizes his keys for keyless entry to the vehicle, the vehicle may identify that John is the driver of the vehicle. When Mary uses her keys to open the vehicle or utilizes her keys for keyless entry to the vehicle, the vehicle may identify that Mary is the driver of the vehicle. When both John and Mary approach the vehicle, the vehicle may identify that the keys closer to the driver side door belong to the individual that is driving the vehicle. In other embodiments, there may be a default designated driver, so if both John and Mary's keys are within detectable range of the vehicle, one of them is defaulted as the driver. Such settings may be modified or changed.

In another example, the object carried or worn by the driver may be a mobile device, such as a smartphone, tablet, or wearable device, of the driver. The mobile device may be capable of communicating directly with the vehicle. In some embodiments, the mobile device may communicate directly with the vehicle with any form of direct wireless communication link such as, but not limited to, Bluetooth, infrared, optical link, Wi-Fi (e.g., Wi-Fi Direct, P2P), near field communication, or any other type of direct communication link. Similar to the scenario with the keys, when John approaches the vehicle with his mobile device, the vehicle may identify that John is the driver of the vehicle. When Mary approaches the vehicle with her mobile device, the vehicle may identify that Mary is the driver of the vehicle. When both John and Mary approach the vehicle, the vehicle may identify that the mobile device closer to the driver side door belongs to the individual that is driving the vehicle. In another example, there may be a default designed driver, so if both John and Mary's mobile devices are within detectable range of the vehicle, one of them is defaulted as the driver. Such settings may be modified or changed.

Any other object may be similarly utilized. For example, the object may be a keychain, dongle, card, box, or any other type of device.

When the surrounding vehicle identifies the driver of the surrounding vehicle, the surrounding vehicle may communicate information associated with the driver to the sensing vehicle. The information associated with the driver may include the driver's identity. The information associated with the driver may include any of the other type of information described elsewhere herein. Any description herein of the driver's identity may apply to any other type of information associated with the driver. The surrounding vehicle may be broadcasting the driver's identity and the sensing vehicle may intercept the broadcast. The surrounding vehicle may communicate directly with the sensing vehicle. The surrounding vehicle may communicate directly with the sensing vehicle via point to point communications. The surrounding vehicle may communicate with the sensing vehicle via indirect communications. The surrounding vehicle may push the driver identity information to the sensing vehicle. The sensing vehicle may pull the driver identity information from the surrounding vehicle. The sensing vehicle may send a query to the surrounding vehicle. The surrounding vehicle may respond to the query by sending the driver identify information.

Any description elsewhere herein of communications between vehicles may apply to the sensing vehicle obtaining the driver identity information from the surrounding vehicle.

As previously described, a surrounding vehicle may enter or exit a detectable range of the sensing vehicle over time. The driver may enter or exit a detectable range over time. For instance, an image of the driver's face may be captured at certain moments of time, but may be obscured or outside the sensors' range at other moments of time. Similarly, the surrounding vehicle may enter or exit a communication range of the sensing vehicle over time. The sensing vehicle and/or other vehicle may track the surrounding vehicle over time. In some instances, multiple vehicles may collectively track the surrounding vehicle over time. If the driver is identified at any point within a period of time during which the vehicle is tracked, the driver identity may be associated with the vehicle during the entirety of the time period. In some instances, a single instance of driver identification may be sufficient to associate the driver identity with the vehicle for a period of time that information about the surrounding vehicle is obtained.

The driver identification may be associated with any information about the surrounding vehicle. This may include positional information about the surrounding vehicle, or any other information as described elsewhere herein. The driver identification may be associated with behavior data of the surrounding vehicle. The driver identification may be an index through which the behavior data of the surrounding vehicle may be accessed.

In some embodiments, a single vehicle may have a single driver associated with the vehicle. For instance, there may be only one regular driver for a particular vehicle. In other instances, a single vehicle may have multiple drivers associated with the vehicle. For instance, there may be multiple drivers, such as multiple members of a household, that may regularly drive the vehicle. Different drivers may have different driving habits. It may be useful to identify a particular driver of a vehicle at a moment in time.

A driver may primarily drive a single car. In some instances, a driver may regularly drive multiple cars. For instance, members of a household may regularly switch cars. Identifying the driver may advantageously permit tracking of driving behavior associated with a particular individual. This may allow aggregation of information relating to a particular driver, even when the driver drives different vehicles.

In some embodiments, a driver may be identified. The driver may or may not be a registered owner of the vehicle. In some embodiments, safe or unsafe driving behavior may have ramifications for the driver. For instance, insurance rates for a driver may go up if the driver engages in unsafe driving behavior. In some embodiments, safe or unsafe driving behavior may have ramifications for an owner of the vehicle, regardless of whether the driver is the owner or not. For instance, if a driver engages in a car pool violation, the owner may still be affected. For instance, unsafe behavior by a driver of a vehicle belonging to an owner may cause the owner's insurance rates to go up.

In some embodiments, depending on the nature of the detected behavior, the driver and/or owner may be affected. For instance, if there are detected issues with vehicle maintenance (e.g., broken tail-like, smoke coming out of the car, etc.) the owner may be affected (e.g., owner's vehicle insurance rates may be adjusted). The driver may or may not be affected with detected vehicle maintenance issues. In another example, if there are detected issues with driving behavior (e.g., speeding, running red light, etc.), the driver may be affected (e.g., the driver's insurance rates may be adjusted). The owner may or may not be affected. For some behaviors, both the owner and driver may be affected. The individual that may be affected by a particular behavior may be an individual who seems the most responsible. For instance, a vehicle owner may be responsible for a vehicle's maintenance and care. A driver may be responsible for actually operating a vehicle safely.

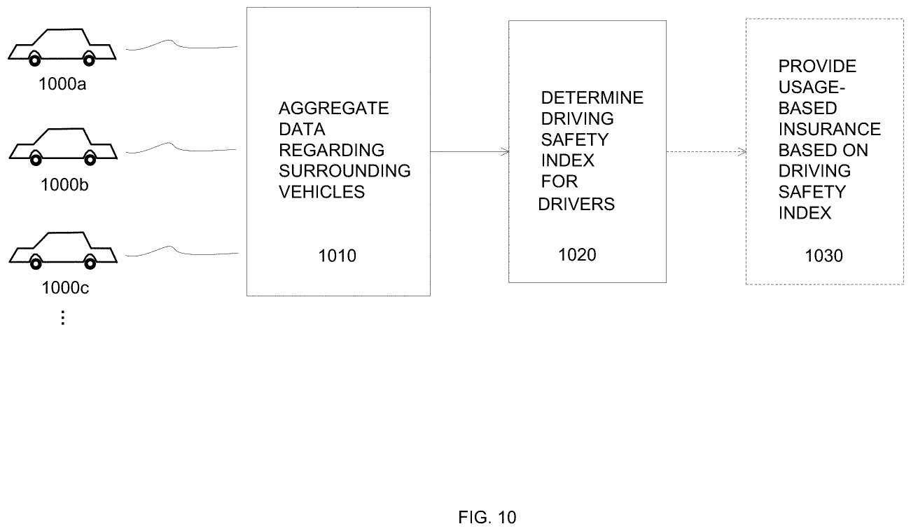

FIG. 10 illustrates an additional example of data aggregation and analysis from one or more sensing vehicles, in accordance with embodiments of the disclosure. One or more sensing vehicles 1000a, 1000b, 1000c may provide information obtained by the one or more sensing vehicles. The information may be received by a data center. The data center may aggregate information received by the one or more sensing vehicles, such as data regarding surrounding vehicles and/or drivers of the surrounding vehicles 1010. The data center may determine a driving safety index for the driver 720. Optionally, usage-based insurance (UBI) may be provided based on the driving safety index 730.

One or more sensing vehicles 1000a, 1000b, 1000c may obtain information about one or more surrounding vehicles and/or the sensing vehicle itself. Any description herein of obtaining and/or analyzing information relating to the one or more surrounding vehicles may also apply to the sensing vehicle itself. The sensing vehicle may obtain information about the one or more surrounding vehicles with aid of one or more sensors and/or communications with the respective surrounding vehicle. Any description provided elsewhere herein of sensing vehicles and collection of data may apply. A single sensing vehicle may provide information. Alternatively, multiple sensing vehicles may provide information.

Information received from the one or more sensing vehicles may be aggregated 1010. Data regarding one or more surrounding vehicles of the various sensing vehicles may be aggregated. The data may include identification information for one or more respective drivers of the one or more surrounding vehicles. Any description herein of the data regarding the one or more surrounding vehicles may also apply to any other information obtained from the one or more sensing vehicles, such as data about the drivers of the surrounding vehicles, the sensing vehicles themselves, or environmental conditions, and vice versa.

As previously described, data may be collected by multiple sensing vehicles. The data may be collected and/or transmitted simultaneously. The data may be collected and transmitted over a period of time. The data collected by the multiple sensing vehicles may or may not overlap. For example a first vehicle 1000a and a second vehicle 1000b may be driving within a same region at approximately the same period of time. The same surrounding vehicles may be detected by the both the first vehicle and the second vehicle. For example the first vehicle and the second vehicle may both collect information about Vehicle A with Driver A, Vehicle B with Driver B and Vehicle C with Driver C. Vehicles A, B, and C may be near both the first and second vehicles. The information about the vehicles may or may not overlap. For instance, the first vehicle may collect information about Vehicle A at exactly the same time that the second vehicle collects information about Vehicle A.

If the information provided by the first and second vehicles are consistent, this may increase the likelihood that the information obtained about Vehicle A at that moment in time is accurate. Data about the multiple sensing vehicles may or may not be stored with a corresponding confidence level. If the data is consistent, the confidence level may be high. If the data is inconsistent, then the confidence level may be lower. In some instances, over time, the system may be able to detect when particular sensing vehicles are regularly providing inconsistent data relative to other vehicles. If that is the case, the data from the aberrant sensing vehicle may be discounted or provided less weight. In some instances, the data from the aberrant sensing vehicle may be ignored altogether. This may also include data about an identity of a driver of Vehicle A. For instance, if multiple sensing vehicles identify the driver of Vehicle A to be the same person, the likelihood of correct identification may be high. If multiple sensing vehicles identify the drive of Vehicle A to be different people, the likelihood of correction identification may be lower.

Driving behavior may be processed based on information from multiple sources. As previously described, weight of certain driving behavior can be corrected according to historical data and/or information from multiple sources. Duplicate information may be eliminated, or close information may be averaged.

In some instances, when the first and second vehicles are in the same area at the same time, they may collect information about one another. For example, the second vehicle may be a surrounding vehicle of the first vehicle and vice versa. The first vehicle may collect information about the second vehicle (e.g., with aid of one or more sensors). The second vehicle may or may not collect information about the first vehicle while the first vehicle is collecting information about the second vehicle. In some instances, this may occur when the second vehicle is within a detectable range of the first vehicle, but the first vehicle is not within a detectable range of the second vehicle. This may be due to placement of the vehicles relative to one another or different detection ranges of the first vehicle and the second vehicle. The information collected may include driver identification for the vehicle.

In some instances, the data collected by some of the sensing vehicle do not overlap. For example a first vehicle 1000a and a third vehicle 1000c may be driving within a different region or at the same region at different times. Different surrounding vehicles may be detected by the first vehicle and the third vehicle. For example the first vehicle may collect information about Vehicles A and B, while the third vehicle may collect information about vehicles C and D. Optionally, the first vehicle may collect information about Vehicle A at a first period in time, and the third vehicle may collect information about Vehicle A at a second period in time different from the first period in time. The first vehicle may not detect the third vehicle and the third vehicle may not detect the first vehicle. Any collected information may include driver identification for a respective vehicle.

The data may be aggregated. Data collected by a single vehicle may be aggregated over time. Data collected by multiple vehicles may be aggregated. As previously described, the data may be indexed and/or associated according to any aspect of the information. The aggregated data may be associated with a driver identifier for a driver of the vehicle that the data is regarding. For instance, a first vehicle may collect information about surrounding Vehicle A, which may be stored and associated with a driver identifier for Driver A of Vehicle A. A second vehicle may also collect information about surrounding Vehicle A, which may be stored with and associated with the driver identifier for Driver A of Vehicle A. In another example, a third sensing vehicle may be Vehicle A and may provide information about itself, such as its location, or forces experienced by it, and may be associated with its driver identifier. Thus, all the data collected over time for various sources relating to a particular driver identifier may be accessed and/or analyzed together. The information collected by the first vehicle, second vehicle, and/or the third vehicle may or may not overlap. Duplicate data may or may not be removed. Data with slight inconsistencies may be averaged, or all sets of data may be stored.

A driving safety index may be determined for a particular driver. The driving safety index may be associated with the driver identifier of the driver. The driver may consistently drive a single vehicle or may drive multiple vehicles. Thus the driving safety index for the driver may pertain to data collected regarding a single vehicle or multiple vehicles. In some instances, all of the aggregated data for a particular driver (e.g., associated with the driver identifier) may be analyzed to generate the driving safety index. This may include all data collected by all sensing vehicles over the entirety of the period of time that the data was collected and stored. Alternatively, a subset of the aggregated data for the vehicle may be analyzed to generate the driving safety index for that driver. For example, the data from only a selected period of time may be analyzed and used to generate the driving safety index for that driver. This may include a most recent selected period of time (e.g., within the past day, within the past week, within the past month, within the past quarter, within the past year, within the past several years, within the past decade). The subset of data may include only data from particular sources or that exceed a particular confidence level. For instance, only data that exceeds a confidence level of 40% or greater, 50% or greater, 60% or greater, 70% or greater, 80% or greater, 90% or greater, 95% or greater, 97% or greater, 99% or greater, or 99.5% or greater may be used to generate the driving safety index.

The driving safety index may be a qualitative or quantitative indicative of how safely a driver tends to operate a vehicle. Unsafe and safe behaviors may be considered. In some embodiments, unsafe driving behaviors may be detected for a particular driver. The unsafe behavior may ‘lower’ a driving safety index. Thus, detected unsafe behavior may indicate that the driver does not tend to drive as safely. The degree to which the driving safety index is lowered may be the same regardless of the type of unsafe behavior. Alternatively, the degree to which the driving safety index is lowered may vary depending on the type of unsafe behavior. For example, behaviors that may be more unsafe may cause the driving safety index to be lowered by a greater amount. For example, getting into an accident (e.g., a collision) with another vehicle may lower the driving safety index by more than cutting off a driver without getting into an accident. The degree to which the driving safety index is lowered may depend on a confidence level associated with the unsafe behavior. For instance, if multiple vehicles corroborate that a particular driver operated a vehicle to perform an unsafe maneuver, the driving safety index may be lowered more than when a single vehicle detects potential unsafe behavior, when that single vehicle has shown that its information is often not consistent with other vehicles.

Unsafe driving behavior may include illegal driving behavior (e.g., driving behavior that violates a law or rule of a jurisdiction within which the vehicle is operating) and/or legal driving behavior that may still be deemed to pose a safety risk. Examples of unsafe driving behavior may include, but are not limited to, speeding (e.g., going over a legal speed limit, or a suggested posted speed limit), running a red light, running a stop sign, not yielding when the vehicle should yield (e.g., to other vehicles, pedestrians), unsafe lane changes or merges (e.g., cutting off other vehicles), stopping in the middle of the road, going outside the lane markers, not stopping for pedestrians, making illegal turns (e.g., right, left, or u-turns when it is unsafe or illegal to do so), driving over curbs or medians, frequent harsh braking, frequent hydroplaning, and/or collisions (e.g., with other vehicles, stationary objects, pedestrians, or animals). Accidents may include collisions, scrapes, or any action that may or may not result in damage to the vehicle or an external object. In some instances, contextual information may be used to determine whether these behaviors are particularly unsafe or whether they were necessary for safe driving under the circumstances. For example, it may be unsafe to brake suddenly and harshly in the middle of the road, but it may be safe or necessary when a deer runs across the street.

Safe behavior may ‘increase’ a driving safety index. Thus, safe behavior shown over time may show that the driver has a tendency to drive safely. The degree to which the driving safety index is increased may be the same regardless of the type of safe behavior. An amount to which the driving safety index is increased may directly correlate to an amount (e.g., length of time, distance) of driving that is performed safely. In some instances, there may be different types of safe behavior, and the degree to which the driving safety index is increased may depend on the type of safe behavior, or a confidence level associated with the data collected that indicated the safe behavior.

Safe behavior may include any behavior that is considered safe, or that is not considered unsafe. Any other description herein pertaining to safe behavior may apply.

A driving safety index may be a quantitative indicator of how safely a driver tends to operate a vehicle. For example, the driving safety index may be a numerical value. In one example, the numerical value may range between a minimum value and a maximum value (e.g., between 1 and 10, or between 0 and 100). The numerical value may be only a whole number, or may include decimals. Alternatively, there may be no minimum or maximum, so as a driver drives safely over a long period of time, the driving safety index may just continue to increase without limit.

A driving safety index may be a qualitative indicator how safely a driver tends to operate a vehicle. For example, the driving safety index may fall within a plurality of categories. Any number of categories may be provided. For example, the categories may be letters. For instance, an ‘A’ driver may represent a very safe driver while an ‘E’ driver may represent a relatively unsafe driver. In another example, categories may include ‘safe driver’, ‘moderately safe driver’, ‘moderate driver’, ‘moderately unsafe driver’, and/or ‘unsafe driver.’ In some instances, the categories may relate to the type of unsafe driving behavior that the driver tends to exhibit. For example, the categories may include ‘speeder’, ‘accident-prone’, ‘ignores traffic lights’, or other types of categories. Any other description herein pertaining to safe driving index for vehicles may apply to driving safety index for drivers and vice versa.

The driving safety index associated with the various drivers may be useful for many further functions or services. For example, UBI may be provided for the drivers. The vehicle insurance may be provided based on how the driver behaves. For instance, the vehicle insurance may depend on how safely a driver tends to operate a vehicle. The vehicle insurance may depend on the driving safety index for that driver. The vehicle insurance may be provided on a driver by driver basis, or may be provided for a particular vehicle, taking into account the identity of the driver(s).

For example, a UBI company may decide whether to offer insurance or not to a driver of a vehicle depending on the driving safety index for that vehicle. If the driving safety index does not exceed a particular threshold, the UBI may not offer any insurance for that driver. In some instances, the UBI may offer insurance but the terms of the insurance may depend on the driving safety index. For example, for higher driving safety indexes for a particular driver, the UBI may offer cheaper rates for particular levels of coverage. Or they may offer a more comprehensive level of coverage. By contrast, for lower driving safety indexes for a particular driver, the UBI may require higher rates for particular levels of coverage. Or they may offer a less comprehensive level of coverage. There may be different categories of insurance packages that may be offered to the vehicles based on a driving safety index of the associated driver(s). For instance, depending on the driving safety index, the vehicle may fall into one or more categories of available insurance packages. Alternatively or in addition, each insurance offering may be personalized to the vehicle based on the driving safety index of the driver(s) of the vehicle, or any other information about the vehicle. Other information about the vehicle, such as driving safety index for the vehicle, vehicle model, make, color, location, commute length, commute frequency, or vehicle history, may be considered in formulating the insurance package.

In one example, insurance may be provided on a driver by driver basis regardless of the vehicle that the driver is driving. The insurance may be provided to a driver by associating the driver with one or more vehicles. The insurance may be provided based on the driver's history, which may include a driving safety index for the driver. In another example, insurance may be provided for a vehicle, and may take into account driving history of one or more drivers that will be listed as drivers for the vehicle. This may include taking into the account a driving safety index for each of the drivers to be listed as drivers for the vehicle. For example, both Driver A and Driver B may be listed as drivers for Vehicle A. Driver A may have a safe driving record, and a high driving safety index. Driver B may have a less safe driving record, and a lower driving safety index. If both drivers are listed as drivers for the vehicle, both of their driving safety indexes may be taken into account. An insurance plan may be formulated based on both of their driving histories. If Driver A is to be listed as a primary driver and Driver B is to be listed as a secondary driver, their driving histories (and/or driving safety indexes) may be weighted equally or Driver A's driving history (and/or driving safety index) may be weighted more.

The UBI may automatically formulate the insurance package based on the driving safety index for a driver and/or vehicle, and/or other factors. The UBI may automatically formulate the package with aid of one or more processors. Alternatively, a human operator may aid in the formulation of the package. The data center may provide information to a UBI system. For instance, the data center may provide the driving safety index to a UBI system. The data center may or may not provide any other information about the driver, a vehicle operated by the driver, or behavior data of the vehicle operated by the driver to the UBI system. The UBI system may comprise one or more servers and/or computing devices. The UBI system may have any characteristics of the data center as described elsewhere herein.

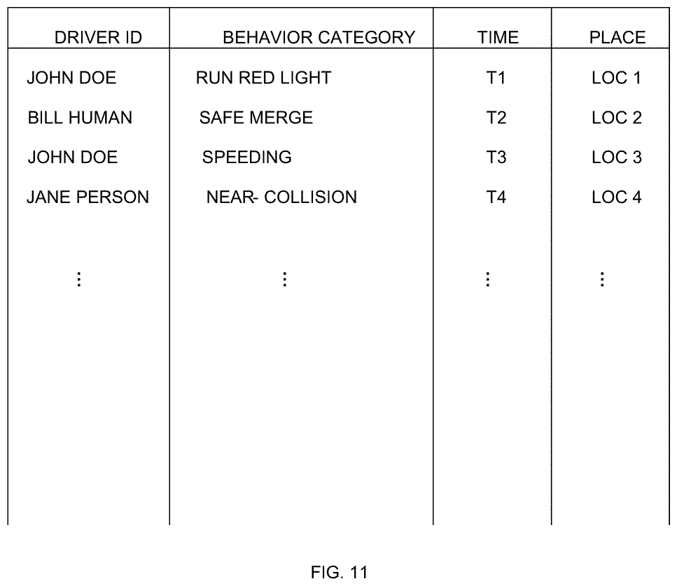

FIG. 11 illustrates an additional example of data that may be collected from one or more sensing vehicles, in accordance with embodiments of the disclosure. As previously described various types of information may be collected and aggregated and/or stored. The information obtained by a particular sensing vehicle may or may not be aggregated and/or stored on-board the sensing vehicle itself. In some instances, a subset of the information obtained may be aggregated and/or stored on-board the sensing vehicle (e.g., within a particular period of time, etc.).

Alternatively or in addition, the information obtained by a sensing vehicle and/or other sensing vehicles may be aggregated and/or stored at a data center. The data center may receive information from multiple sensing vehicles. The information from the multiple sensing vehicles and/or other sensing vehicles may be stored and/or aggregated at the data center. Any description herein of the information stored may apply to information stored on-board the sensing vehicle, other sensing vehicles, at the data center, on a separate storage medium, or any combination thereof.

In some instances, identifying information, behavior information, and/or contextual information may be stored and/or associated with another. For example, information may be stored as a driver identifier+behavior data+time+location.

Examples of driver identifiers may include a driver's name (as shown in FIG. 11), driver's license information, driver's social security number, randomly generated unique identifiers, or any other type of identifying information for a driver, as described elsewhere herein.

The behavior data may include any level of specificity relating to the behavior of the vehicle being operated by the driver. For example, behavior categories may be provided that may be indicative of the type of behavior detected for the vehicle operated by the driver. In some instances, only unsafe behavior categories are provided and/or stored (e.g., run red light, speeding, near-collision, as illustrated in FIG. 11). Alternatively or in addition, one or more safe behavior categories or details may be provided and/or stored (e.g., safe merge, as illustrated in FIG. 11). The behavior data may include specific details about the behavior data. For example, in addition to merely identifying that a driver drove a vehicle to run a red light, the behavior data may specify the location of the red light, how fast the vehicle was going, the direction the vehicle was traveling, whether there were any other vehicles in the intersection, or any other information associated with the driving behavior. The behavior data may include location data for the one or more surrounding vehicles.

The contextual information may include time and location information. The time may be a time at which the behavior data was collected. The location may be a location of the vehicle performing the behavior data, or a location of the sensing vehicle obtaining information about the behavior data. The contextual information may be any other type of information, as described elsewhere herein.

The driver identifiers may be used to determine whether the various entries are associated with a particular driver. For example, JOHN DOE shows up multiple times, which indicates that the associated behavior was performed by the same driver. For example, JOHN DOE both ran a red light at time T1 at location LOC1, and was speeding at time T3 and location LOC 3. Information about behaviors about the other drivers (e.g., BILL HUMAN, JANE DOE) may be stored and accessible.

Alternatively or in addition, vehicle identifiers may be used to determine whether the various entries are associated with a particular vehicle. For example, only a vehicle identifier may be provided, as illustrated in FIG. 8. In another example, both the vehicle identifier and the driver identifier may be used. Thus, the information may be accessed and/or analyzed in relation to the vehicle identity and/or the driver identity. For example, driver John Doe may be driving the same vehicle, Vehicle A when he runs the red light and when he is speeding. In another example, driver John Doe may be driving different vehicles, e.g., Vehicle A when he runs the red light and Vehicle B when he is speeding. It may be useful to see if driver behavior differs from vehicle to vehicle. For example, some drivers may be more comfortable driving a smaller vehicle and may drive more safely with a small vehicle. This type of granularity may advantageously be captured by providing both driver and vehicle identifiers which may allow analysis of the behavior data in both the context of the driver and the vehicle.

Alternatively or in addition, information about the source of the information (e.g., sensing vehicle that provided the information, sensors that collected the information, surrounding vehicle that communicated the information) may be stored. Additional information, such as environmental conditions, and/or vehicle information, may be stored.

As described elsewhere herein, data may be collected and/or aggregated with aid of one or more sensing vehicles. The data may be about various target vehicles and/or drivers of the vehicles. In some embodiments, data may be collected and/or analyzed without violating privacy of various vehicle operators and/or owners. For instance, drivers and/or owners of a sensing vehicle may not be able to view any data collected about the one or more surrounding vehicles. In other instances, the drivers and/or owners of a sensing vehicle may be able to view some data collected about the one or more surrounding vehicles but may not view the rest of the data collected about the one or more surrounding vehicles. The drivers and/or owners of the sensing vehicle may not view private information about the one or more surrounding vehicles. This may include not allowing drivers and/or owners of the sensing vehicle to see personal information about the drivers and/owners of the one or more surrounding vehicles. For example, if a driver identity of a surrounding vehicle is detected, the driver and/or owner of the sensing vehicle may not see the driver identity. The driver identity and/or any other personal information about the driver may not be viewed by any unauthorized individual. In some instances, certain information about the surrounding vehicle (e.g., vehicle VIN number, accident history, address of registration, etc.) may also be private and not readily viewable by unauthorized individuals. All or some of the data may be encrypted so that unauthorized individuals may not view the data. In some instances, data may be modified so that unauthorized may not be able to interpret the data. For example, driver names of sensed surrounding vehicles (e.g., target vehicles) may be hashed. That way, if anyone intercepts a communication or accesses the data, the driver's identity may still be protected. Similarly, any sensitive information such as information about the driver (e.g., driver name, driver license information, driver date of birth, driver car insurance information, driver address, driver contact information, driver social security, driver's driving history), information about the owner (e.g., owner name, owner license information, owner date of birth, owner car insurance information, owner address, owner contact information, owner social security, owner's driving history), and/or information about the vehicle (e.g., vehicle identification number, vehicle license plate, vehicle accident history, vehicle maintenance history, vehicle driving history (e.g., where the vehicle has been)), may be encrypted, hashed, or protected in any other manner.

In some embodiments, the sensing vehicles and/or data center may collect and/or analyze information. Individuals associated with the sensing vehicle and/or data centers may have only limited access to the data collected. The individuals associated with the sensing vehicle and/or data centers may not access the data collected but may access certain analyzed aspects of the data. Individuals associated with the sensing vehicles and/or data centers may not access certain private information about the various target vehicles that were sensed (such as information about drivers and/or owners of the various target vehicles that were sensed). For example, a user of a data center may not be able to access specific personal information about various drivers and/or owners of vehicles. A user of a data center may not specifically access a history of everywhere that a vehicle has been. A user of a data center may access certain data analysis, such as a safe driving index for a vehicle. UBIs or other services may only receive relevant information. For example, UBIs may merely receive a safe driving index for a particular vehicle and/or driver without receiving details of specific driving behavior, such as details of where the vehicle has been, images of the driver operating the vehicle. The data at the data center may be encrypted so that only authorized individuals may access certain data.

Sensitive data may be protected. Unauthorized individuals may not be able to access sensitive data. In some instances, the system may be a closed system and no individuals may be able to access the sensitive data. The sensitive data may merely be used by one or more processors to analyze collected data. Only certain indices or generalizations about the data sets may be accessed by individuals. Alternatively, only limited, authorized individuals may be able to access the sensitive data.

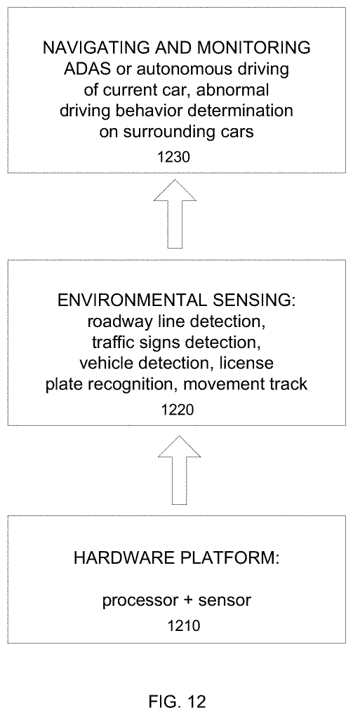

FIG. 12 shows an example of a functional hierarchy of a vehicle system, in accordance with embodiments of the disclosure. A hardware platform 1210, environmental sensing 1220, and/or navigating and monitoring 1230 may be provided.

A hardware platform 1210 may comprise any hardware useful for implementing a vehicle monitoring system. For example, the hardware may comprise one or more processors and/or one or more sensors. The processors and may be on-board a sensing vehicle or off-board the sensing vehicle. The processors may be at a data center in communication with the sensing vehicle. The one or more sensors may be on-board the sensing vehicle. The sensors may comprise external sensors that may capture information about an environment around the sensing vehicle, such as one or more surrounding vehicles. The sensors may comprise internal sensors that may capture information about the sensing vehicle itself. Additional examples hardware may include communication units that may enable wireless communication of information to or from the sensing vehicle.

The system may be capable of performing environmental sensing 1220. Environmental sensing may comprise sensing one or more conditions of the environment that may be useful for operation of the vehicle. For instance, it may include detecting and/or recognizing objects or markers within the environment. Environmental sensing may comprise activities such as roadway line detection, traffic sign detection, traffic light detection, walkway detection, median detection, vehicle detection, driver detection, license plate recognition, driver recognition, and/or tracking of movement.

Environmental sensing may be performed with aid of one or more components of the hardware platform. For example, one or more sensors may sense environmental information. For example, an image sensor may capture an image of a traffic sign. One or more processors may aid with recognition of the detected object. For example, the one or more processors may analyze the image of the traffic sign to recognize the traffic sign. The one or more processors may recognize the type of traffic sign (e.g. recognize a stop sign vs a yield sign, etc.) and/or utilize optical character recognition to extract information written on the traffic sign.

The system may be useful for navigating and monitoring 1230. The system may aid in a sensing vehicle navigating within an environment. The system may aid in permitting autonomous or semi-autonomous navigation by the sensing vehicle. The system may permit manual navigation by a driver of the sensing vehicle but may provide automated assistance at moments in time. For instance, navigation and monitoring may include advanced driver assistance systems (ADAS) or autonomous driving of vehicles, or for detecting abnormal driving behavior of surrounding vehicles or the sensing vehicle itself. The system may help prevent collision. The system may provide warnings if the vehicle is performing an unsafe maneuver or about to perform an unsafe maneuver. For example, the system may automatically cause the vehicle to brake when detecting an obstruction. The system may prevent the vehicle from switching lanes or may provide a warning if a surrounding vehicle is in the sensing vehicle's blind spot.

Navigation and monitoring may be performed with aid of the environmental sensing capabilities. This may ultimately utilize one or more components of the hardware platform. For example, the environmental sensing capabilities may recognize the edges of lanes. This may aid in allowing a vehicle to navigate within the lanes. The environmental sensing capabilities may recognize one or more signs or traffic lights. This may aid in allowing the vehicle to operate in accordance with one or more traffic rules. The environmental sensing capabilities may also keep track of behavior of one or more surrounding vehicles. This may aid in allowing the vehicle to navigate and perform any necessary collision avoidance maneuvers. Such maneuvers may occur autonomously or semi-autonomously. For example, while a driver is operating a vehicle manually, the driver assistance may kick in to override certain maneuvers by the driver for safety reasons. For example, if the driver is about to switch lanes, but there is a surrounding vehicle within the driver's blind spot, the sensing vehicle may prevent the driver from changing lanes into the vehicle. Similarly, if the driver is driving along a road, and a sensor detects an object in the vehicle's path, the driving assistance may cause the vehicle to automatically brake and/or swerve. Optionally, warning may be provided. For example, if the driver is about to make the lane change and there is a vehicle in the way, an audio, visual, and/or tactile warning may be provided to the driver so that the driver knows not to change lanes.

In some instances, a sensing vehicle may be capable of driving autonomously within an environment. A driver of the vehicle need not actively operate the vehicle. In some instances, a driver of a vehicle may enter a manual driving mode from the autonomous mode, or vice versa. The vehicle monitoring systems provided herein may aid in capturing information about an environment about the sensing vehicle with aid of sensors on-board the sensing vehicle and/or one or more surrounding vehicles, which may improve autonomous driving capabilities. An autonomous vehicle need not rely solely on sensors on-board the sensing vehicle, but may receive information collected by sensors on-board surrounding vehicles, which may improve accuracy and/or visibility of the environmental conditions.

The system may be useful for traffic monitoring. This may include determination of how heavy traffic is at certain locations. This may also include estimation of how long it will take to drive from one location to another. This may aid in trip planning, navigation, accident notification, and other functions. The system may permit traffic monitoring based on data collected by one or more sensing vehicles. This may permit the traffic monitoring to not be limited by cameras installed at road junctions. The data collection by sensing vehicles of surrounding vehicles may also provide more data and granularity compared to information from sensing vehicles or devices on-board the sensing vehicles about only the sensing vehicles themselves. Data collection of surrounding vehicles may allow for data to be cross-checked and may provide more details about traffic that may not otherwise be available (e.g., if the surrounding vehicles are not providing any data themselves). For example, a more accurate measurement of traffic may be made when sensing vehicles provide information about surrounding vehicles, and not just the sensing vehicles, since one or more of the sensing vehicles may not be providing information about themselves.

The system may be used to determine if a vehicle identifier (e.g., license plate) has been cloned. For instance, data may be collected from multiple sensing vehicles and associated with the vehicle identifier. Abnormal times and locations of vehicles with a particular vehicle identifier may be analyzed. For instance, a vehicle with a particular license plate may be detected in Southern California at 4 pm on Friday. At 4:30 pm, a vehicle with the same license plate may be detected in Oregon. Since it would not be possible for the vehicle to have traveled that distance in that period of time, it is likely that at least one of the license plates is a copy. Time and/or date information may be analyzed to detect such anomalies and detect possibilities of license plate cloning.

Physical characteristics of the vehicle may be detected and/or analyzed by the systems and methods provided herein. For example, vehicle color, type, make, model, or any other characteristic may be detected and/or analyzed by the system. In some embodiments, such physical characteristic information may be useful for detecting license plate cloning. For example, if a particular license plate is registered with a particular type of vehicle (e.g., License Plate A is registered with a red pickup truck), and the image shows the license plate on a different type of vehicle (e.g., License Plate A is on a blue sedan), there may be an increased likelihood that the license plate has been stolen or cloned. Similarly, if two vehicles are detected with the same license plate, the physical characteristics of the vehicles may be used to determining which of the license plates is likely cloned, or whether both are likely cloned.

The system may provide feedback that may be useful to one or more drivers of the various vehicles. The feedback may aid in improving overall driving behavior by the drivers. The system may aid in changing individual's driving habits. Safe driving behaviors may be encouraged.

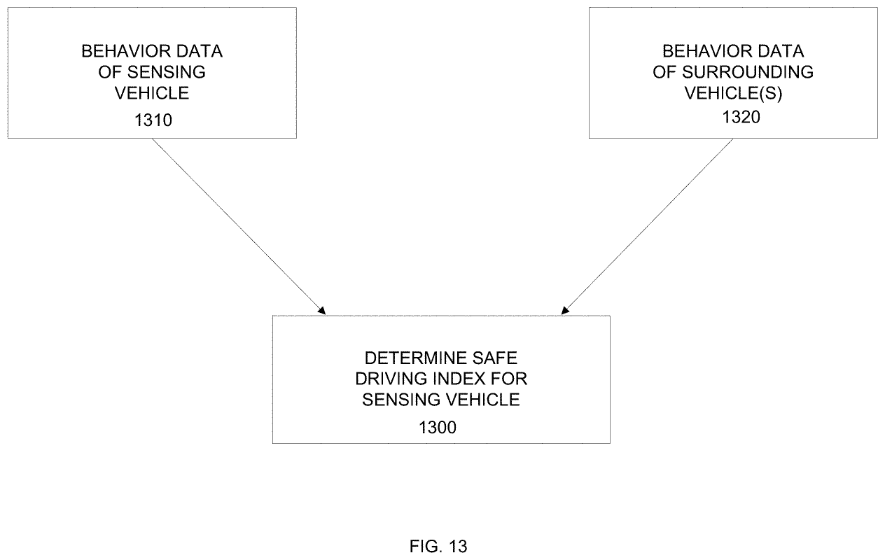

FIG. 13 provides an illustration of data analysis for determining a safe driving index for a sensing vehicle, in accordance with embodiments of the disclosure. A driving safety index may be generated for a sensing vehicle 1300. The driving safety index may be generated based on behavior data of the sensing vehicle 1310. The driving safety index may be generated based on the behavior data of one or more surrounding vehicles as well 1320. The driving safety index may be generated based on a combination of behavior data of the sensing vehicle and the behavior data of the one or more surrounding vehicles.

The behavior data of the sensing vehicle may be determined with aid of one or more sensors on-board the vehicle. The sensors may be internal sensors that may detect a condition of the sensing vehicle. The sensors may have any characteristics of internal sensors as previously described. For instance, the sensors may comprise GPS sensors, inertial sensors (e.g., accelerometers, gyroscopes, magnetometers), pressure sensors, temperature sensors, and/or any other type of sensor. The sensors may be capable of detecting position of the vehicle on a two-dimensional surface within a three-dimensional space. The sensors may be capable of detecting movement of the vehicle. The sensors may be capable of detecting forces on the vehicle from any direction.

The behavior data may be determined with aid of one or more sensors on-board an object carried on-board the vehicle. The object may be removable from the vehicle. The sensors may be removable from the vehicle. The sensors may or may not be removable from the object. The object may be carried by a driver or passenger of the vehicle. The object may be mobile device (e.g., smartphone, tablet, personal digital assistant) and/or wearable device (e.g., watch, glasses, armband, hat, pendant, ring, bracelet). The objects may have sensors that may be useful for detecting behavior of the sensing vehicle. The sensors on-board the object may be any type of sensors as described elsewhere herein, such as internal sensors of the vehicle. The sensors may comprise GPS sensors, inertial sensors (e.g., accelerometers, gyroscopes, magnetometers), pressure sensors, temperature sensors, and/or any other type of sensor. The sensors may be capable of detecting position of the object on a two-dimensional surface within a three-dimensional space. The sensors may be capable of detecting movement of the object. The sensors may be capable of detecting forces on the object from any direction. The information associated with the object may be attributed to the vehicle since the vehicle carries the object on-board. For example, the location of the object may be the same as the vehicle when the object is within the vehicle. The forces experienced by the object may be approximated to be the force on the vehicle when the object is carried within the vehicle, particularly when the object is stationary with respect to the vehicle. Any description of sensors on-board the sensing vehicle collecting behavior data for the sensing vehicle may also apply to objects with sensors carried by the sensing vehicle, and vice versa.

The behavior data of the one or more surrounding vehicles may be determined with aid of one or more sensors on-board the sensing vehicle. The sensors may be external sensors that may detect an environment outside the sensing vehicle. For instance, the environment outside the sensing vehicles may include one or more surrounding vehicles. The sensors may have any characteristics of external sensors as previously described. For instance, the sensors may comprise image sensors, ultrasonic sensors, audio sensors, infrared sensors, lidar, and/or any other type of sensor. The sensors may be capable of detecting position of the surrounding vehicles on a two-dimensional surface or within a three-dimensional space. The sensors may be capable of detecting movement of the one or more surrounding vehicle.

The behavior data of the one or more surrounding vehicles may be determined based on communications with the one or more surrounding vehicles. Any description herein of information about the one or more surrounding vehicles detected with aid of sensors on-board the sensing vehicle may also apply to communications received from the one or more surrounding vehicles.

In some embodiments, the behavior of the sensing vehicle may be analyzed within the context of one or more surrounding vehicles or other environmental factors. For instance, a behavior by the sensing vehicle that may otherwise be deemed unsafe may be deemed safe in view of the context. For instance, if the sensing vehicle swerves suddenly for no reason, that may be determined to be unsafe driving behavior. However, if the sensing vehicle swerves suddenly to avoid a surrounding vehicle that has suddenly cut of the sensing vehicle such a move may be necessary and may not be deemed to be unsafe.

The driving safety index of the sensing vehicle may depend on the analyzed behavior of the sensing vehicle. If the sensing vehicle performs an action that is deemed to be unsafe, the driving safety index may be lowered. If the sensing vehicle performs an action that is deemed to be safe, the driving safety index may remain the same or may be increased. As previously mentioned, whether the sensing vehicle action is safe or unsafe may be analyzed within the context of the behavior data of the one or more

It should be understood from the foregoing that, while particular implementations have been illustrated and described, various modifications can be made thereto and are contemplated herein. It is also not intended that the disclosure be limited by the specific examples provided within the specification. While the disclosure has been described with reference to the aforementioned specification, the descriptions and illustrations of the embodiments herein are not meant to be construed in a limiting sense. Furthermore, it shall be understood that all aspects of the disclosure are not limited to the specific depictions, configurations or relative proportions set forth herein which depend upon a variety of conditions and variables. Various modifications in form and detail of the embodiments of the disclosure will be apparent to a person skilled in the art. It is therefore contemplated that the disclosure shall also cover any such modifications, variations and equivalents.

What is claimed is:

1. A method of analyzing vehicle data comprising:
collecting, with aid of one or more sensors on-board a sensing vehicle, behavior data of one or more surrounding vehicles; and
analyzing, with aid of one or more processors, the behavior data of the one or more surrounding vehicles to determine a safe driving index for each of the one or more surrounding vehicles.

2. The method of claim 1, wherein the one or more sensors on-board the sensing vehicle comprise at least one of an image sensor configured to capture one or more images of the one or more surrounding vehicles, an ultrasonic sensor, a laser radar, a microwave radar, an infrared sensor, or a GPS.

3. The method of claim 1, wherein the one or more sensors are configured to collect information that spans an aggregated amount of at least 180 degrees around the sensing vehicle.

4. The method of claim 1, wherein the sensing vehicle is configured to communicate with the one or more surrounding vehicles wirelessly.

5. The method of claim 1, wherein the sensing vehicle comprises on-board navigational sensors.

6. The method of claim 5, wherein the on-board navigational sensors comprise at least one of a GPS sensor or an inertial sensor.

7. The method of claim 1, wherein the one or more processors are provided off-board the sensing vehicle.

8. The method of claim 7, wherein the one or more processors are provided at a data center remote to the sensing vehicle.

9. The method of claim 8, wherein the sensing vehicle is configured to communicate with the data center wirelessly with aid of a communication unit on-board the sensing vehicle.

10. The method of claim 1, wherein:
the sensing vehicle is one of a plurality of sensing vehicles; and
the one or more processors are configured to receive information collected by the plurality of sensing vehicles.

11. The method of claim 1, wherein:
the sensing vehicle is one of a plurality of sensing vehicles; and
the one or more processors are configured to receive information regarding at least one of the one or more surrounding vehicles collected by the plurality of sensing vehicles.

12. The method of claim 1, wherein the behavior data includes data associated with detection of unsafe driving behavior.

13. The method of claim 12, wherein the behavior data includes data associated with detection of running a red light or speeding.

14. The method of claim 12, wherein the safe driving index of a specified one of the one or more surrounding vehicles is determined to be lower with detection of an increased amount of unsafe driving behavior of the specified one of the one or more surrounding vehicles.

15. The method of claim 1, wherein the behavior data includes data associated with detection of at least one of lane changing behavior or an accident of the one or more surrounding vehicles.

16. The method of claim 1, wherein the behavior data includes data associated with detection of safe driving behavior.

17. The method of claim 16, wherein the safe driving index of a specified one of the one or more surrounding vehicles is determined to be higher with detection of an increased amount of safe driving behavior of the specified one of the one or more surrounding vehicles.

18. The method of claim 1, wherein the safe driving index of a specified one of the one or more surrounding vehicles is determined further based on data collected by at least one of one or more sensors on-board the specified one of the one or more surrounding vehicles or a device carried by a passenger of the specified one of the one or more surrounding vehicles.

19. The method of claim 1, further comprising:
providing a usage-based insurance for the one or more surrounding vehicles based on the safe driving index of the one or more surrounding vehicles; or
providing advanced driving assistance to the sensing vehicle based on the behavior data.

20. A system for analyzing vehicle data comprising:
one or more sensors on-board a sensing vehicle, wherein the one or more sensors are configured to collect behavior data of one or more surrounding vehicles; and
one or more processors configured to analyze the behavior data of the one or more surrounding vehicles to determine a safe driving index for each of the one or more surrounding vehicles.
